(19) United States
(12) Patent Application Publication
(10) Pub. No.: US 2026/0343352 A1
(43) Pub. Date: Oct. 29, 2026

(54) CLIENT AND ACCESS POINT BEHAVIOR FOR SEAMLESS ROAMING THROUGH TARGET ACCESS POINT

(71) Applicant: Cisco Technology, Inc., San Jose, CA (US)

(72) Inventors: Binita GUPTA, San Diego, CA (US); Brian D. HART, Sunnyvale, CA (US); Sudhir K. JAIN, Fremont, CA (US); Malcolm M. SMITH, Richardson, TX (US)

(21) Appl. No.: 19/468,982

(22) Filed: Feb. 3, 2026

Related U.S. Application Data
(60) Provisional application No. 63/754,476, filed on Feb. 5, 2025.
(60) Provisional application No. 63/766,285, filed on Mar. 3, 2025.

(51) Int. Cl. H04W 36/08; H04L 9/30; H04W 12/041; H04W 12/106; H04W 88/08

(52) U.S. Cl. CPC H04W 36/08; H04L 9/3013; H04W 12/041; H04W 12/106; H04L 2209/80; H04W 88/08

(57) ABSTRACT

An example technique includes determining that a wireless network supports seamless roaming within a seamless mobility domain (SMD) using a single pairwise transient key (PTK) mode or a different PTK mode. In single PTK mode, a single PTK is shared across multiple access point (AP) multi-link devices (MLDs) of the SMD. In different PTK mode, a separate PTK is generated for each AP MLD. The SMD is associated with using the single PTK mode or the different PTK mode. While associated with the SMD and communicating with a first AP MLD, a second AP MLD is selected for roaming. A roaming request frame is transmitted to the second AP MLD. A roaming response frame is received from the second AP MLD indicating whether the roaming is successful. Communication is performed with the second AP MLD and secured using the single PTK or the separate PTK for the second AP MLD.

### CROSS-REFERENCE TO RELATED APPLICATIONS

This application claims benefit of co-pending United States provisional patent application Ser. No. 63/754,476 filed Feb. 5, 2025 and co-pending United States provisional patent application Ser. No. 63/766,285 filed Mar. 3, 2025. The aforementioned related patent applications are herein incorporated by reference in their entirety.

### TECHNICAL FIELD

Embodiments presented in this disclosure generally relate to wireless communication. More specifically, embodiments in this disclosure relate to techniques for facilitating seamless roaming among access points (APs) of a seamless mobility domain in a wireless network.

### BACKGROUND

Wireless local area networks increasingly support mobility scenarios in which a client device transitions between multiple APs while maintaining ongoing communications. To reduce latency and packet loss during such transitions, wireless networks may be organized into a seamless mobility domain (SMD) in which multiple AP multi-link devices (MLDs) (AP MLDs) cooperate to provide continuous connectivity to client devices.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system, according to certain embodiments.

FIG. 2 illustrates an example architecture of a multi-link device, according to certain embodiments.

FIGS. 3-7 illustrate various example call flow diagrams for seamless roaming, according to certain embodiments.

FIGS. 8-13 are flowcharts of different methods for wireless communications, according to certain embodiments.

FIG. 14 illustrates an example computing device, according to certain embodiments.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment in this disclosure provides a computer-implemented method for wireless communication performed by a client device. The computer-implemented method includes determining that a wireless network supports seamless roaming within a seamless mobility domain (SMD) using a single pairwise transient key (PTK) mode where a single PTK is shared across a plurality of access point (AP) multi-link devices (MLDs) of the SMD. The computer-implemented method also includes associating with the SMD using the single PTK mode. The computer-implemented method also includes selecting, while associated with the SMD and communicating via a first AP MLD of the plurality of AP MLDs, a second AP MLD of the plurality of AP MLDs for roaming without performing a roaming preparation procedure via the first AP MLD. The computer-implemented method also includes transmitting a roaming request frame to the second AP MLD. The roaming request frame includes one or more parameters associated with seamless roaming within the SMD. The computer-implemented method also includes receiving, from the second AP MLD in response to the roaming request frame, a roaming response frame indicating whether the roaming is successful. The computer-implemented method further includes, responsive to determining the roaming is successful, communicating with the second AP MLD to exchange one or more data frames. The communication is secured using the single PTK.

Another embodiment presented in this disclosure provides a computer-implemented method for wireless communication performed by a client device. The computer-implemented method includes determining that a wireless network supports seamless roaming within a seamless mobility domain (SMD) using a different pairwise transient key (PTK) mode where a separate PTK is generated for each access point (AP) multi-link device (MLD) of a plurality of AP MLDs of the SMD. The computer-implemented method also includes associating with the SMD using the different PTK mode. The computer-implemented method also includes selecting, while associated with the SMD and communicating via a first AP MLD of the plurality of AP MLDs, a second AP MLD of the plurality of AP MLDs for roaming. The computer-implemented method also includes transmitting a roaming request frame to the second AP MLD. The roaming request frame includes one or more parameters associated with seamless roaming within the SMD. The computer-implemented method also includes receiving, from the second AP MLD in response to the roaming request frame, a roaming response frame indicating whether the roaming is successful. The computer-implemented method further includes responsive to determining the roaming is successful, communicating with the second AP MLD to exchange one or more data frames. The communication is secured using a PTK associated with the second AP MLD.

Other embodiments provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a non-transitory computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

### Example Embodiments

In certain wireless systems, roaming between APs often relies on pre-roaming preparation procedures, in which a serving AP coordinates with one or more target APs prior to the client device initiating a roam. Such preparation procedures may involve the exchange of security context, keying material, and/or capability information through the serving AP. While effective in some deployments, these approaches can introduce additional signaling overhead, increase latency, and/or complicate roaming when the serving AP is unavailable, overloaded, or otherwise unable to participate in the preparation exchange.

Other approaches generally involve the establishment of separate pairwise transient keys (PTKs) for each AP prior to roaming or rely on fast transition mechanisms that assume the presence of pre-existing trust relationships and coordination paths between APs. These assumptions do not always hold in dense, distributed, and/or dynamically configured wireless networks, particularly in multi-link environments where an AP MLD may include multiple APs operating across different links and/or frequency bands.

In particular, conventional systems do not adequately address scenarios in which a client device initiates roaming directly with a target AP MLD using (i) a single PTK shared across an SMD or (ii) using a PTK specific to the target AP MLD, without assuming that the target AP MLD has already participated in a roaming preparation exchange via the serving AP MLD. In such scenarios, the target AP MLD generally has to be able to securely identify the client device, determine an appropriate security association, and decide whether to accept the roaming request based on information carried in one or more management frames transmitted by the client device.

Certain embodiments described herein provide techniques, systems, and apparatus for improved seamless roaming of a client device when initiating roaming directly with a target AP. For example, in certain embodiments, techniques are provided that enable a client device to securely roam between AP MLDs within an SMD by exchanging management frames that carry parameters usable by a target AP MLD to determine and apply an appropriate pairwise transient key security association (PTKSA), without relying on mandatory pre-roaming coordination through a serving AP MLD. The disclosed techniques support multiple roaming models, including roaming using a single PTK shared across the SMD, roaming using a PTK specific to the target AP MLD, and roaming in which a preparation exchange itself establishes a new PTK without a separate roaming execution phase.

By enabling the target AP MLD to map addresses or identifiers received in roaming-related frames to PTKSAs, verify message integrity over encrypted and unencrypted frame portions, and selectively establish (or derive) cryptographic keys, the disclosed techniques provide a significant improvement to wireless network operation. These improvements can reduce roaming latency, lower signaling overhead, and enhance security robustness in multi-link wireless network environments, thereby improving the performance and operation of wireless communication systems.

Although the terms “first,” “second,” “third,” etc., may be used herein to describe various elements, components, regions, layers and/or sections, these elements, components, regions, layers and/or sections should not be limited by these terms. These terms may be only used to distinguish one element, component, region, layer or section from another element, component, region, layer, or section. Terms such as “first,” “second,” and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12”. As used herein, the terms “carrier,” “subcarrier,” “frequency channel,” “channel unit,” “channel,” and “tone” may be used interchangeably to refer to a frequency unit (or unit of frequency).

Note, the techniques described herein for facilitating seamless roaming among multiple AP MLDs within an SMD via a target AP MLD may be incorporated into (such as implemented within or performed by) a variety of wired or wireless apparatuses (such as nodes). In some implementations, a node includes a wireless node. Such wireless nodes may provide, for example, connectivity to or from a network (such as a wide area network (WAN) such as the Internet or a cellular network) via a wired or wireless communication link. In some implementations, a wireless node may include an AP, a controller, or a station (STA).

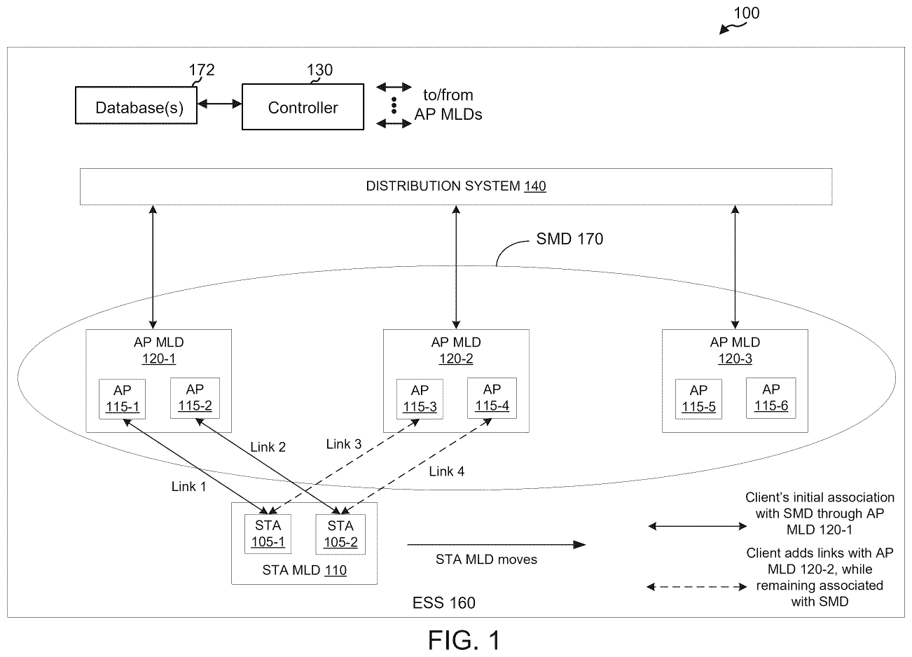

FIG. 1 illustrates an example system 100 in which one or more techniques described herein can be implemented, according to certain embodiments. As shown, the system 100 includes, without limitation, an extended service set (ESS) 160 (e.g., a campus/ESS network), which includes one or more basic service sets (BSSs) (not shown). ESS 160 includes an SMD 170, one or more AP MLDs 120 (e.g., AP MLD 120-1, AP MLD 120-2, and AP MLD 120-3) within the SMD 170, a STA MLD 110, a distribution system (DS) 140, a controller 130, and one or more databases 172.

Note although FIG. 1 depicts ESS 160 including a single SMD 170, in certain embodiments, the ESS 160 can be configured with multiple SMDs, each with one or more AP MLDs. By way of example, the ESS 160 can be used to cover multiple buildings of a campus (or large geographical area), where each building (or smaller geographical area within the larger geographical area) is covered by a respective SMD.

An AP MLD communicates with STA MLD(s) and may also be referred to as a base station, a network entity, a wireless device, or some other terminology. A STA MLD may be fixed or mobile and also may be referred to as a mobile STA MLD, a client MLD, a client STA MLD, a client device, a wireless device, a non-AP MLD, or some other terminology. Note that while a certain number of AP MLDs and STA MLDs are depicted, the system 100 may include any number of AP MLDs and STA MLDs.

As used herein, an AP MLD along with the STA MLDs connected with the AP MLD (e.g., within the coverage area (or cell) of the AP MLD) may be referred to as a BSS. The AP MLD 120-1, AP 120-2, and AP 120-3 may be neighboring (peer) AP MLDs with respect to each other. The AP MLDs 120 may communicate with one or more STA MLDs 110 on the downlink and uplink. The downlink (e.g., forward link(s)) is the communication link(s) from the AP 120 MLD to the STA MLD(s) 110, and the uplink (e.g., reverse link(s)) is the communication link(s) from the STA MLD(s) 110 to the AP 120. In some cases, a STA MLD may also communicate peer-to-peer with another STA MLD.

The AP MLDs 120 and the STA MLD 110 are generally representative of any device capable of performing multi-link operations. Each AP MLD 120 includes two APs (which may be referred to herein as “radios” or “links”). As illustrated, AP MLD 120-1 includes AP 115-1 and AP 115-2, AP MLD 120-2 includes AP 115-3 and AP 115-4, and AP MLD 120-3 includes AP 115-5 and AP 115-6. Similarly, STA MLD 110 includes two STAs 105-1 and 105-2 (which may be referred to herein as “radios” or “links”).

As used herein, the term “radio” may refer to the capability to connect to a peer device on a link. Thus, by way of example, the two APs 115-1 and 115-2, as depicted within AP MLD 120-1, may represent either two physical radios or two logical radios enabled by a single physical radio (which is capable of being used on two different links in a time-switched fashion). Similarly, the two STAs 105-1 and 105-2, as depicted within STA MLD 110, may represent either two physical radios or two logical radios enabled by a single physical radio (which is capable of being used on two different links in a time-switched fashion).

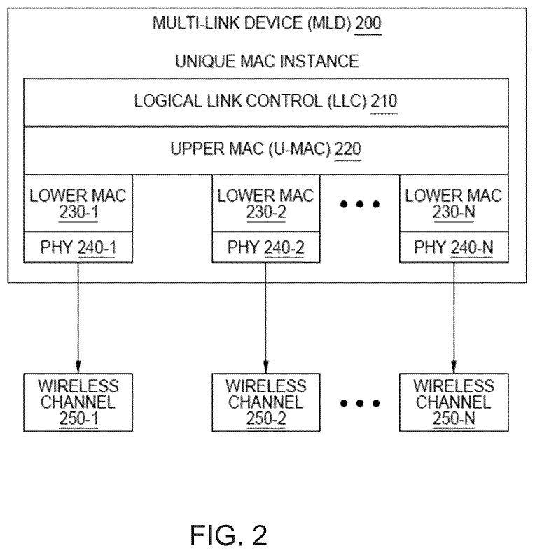

FIG. 2 illustrates an example architecture of an MLD 200, according to certain embodiments. The MLD 200 may be an AP MLD 120 or a STA MLD 110. As depicted in FIG. 2, the MLD 200 provides a unique MAC instance to multiple wireless interfaces (e.g., wireless channels 250 1-N), each of which may be utilized by a respective “radio” (e.g., AP 115 or STA 105). The MLD 200 includes a logical link control (LLC) layer 210 and an upper MAC (U-MAC) layer 220. The upper MAC layer 220 is a common part of the MAC sub-layer for all the interfaces (e.g., wireless channels 250 1-N). The MLD 200 also includes a respective lower MAC (L-MAC) 230 1-N for each interface. Each respective L-MAC 230 manages a corresponding physical (PHY) layer 240 as well as link specific functionalities (e.g., channel access) for the corresponding wireless channel 250.

An MLD may generally be classified based on whether it is a single radio MLD or multi-radio MLD. Single radio MLDs generally use a single radio to switch between one or more links. One category of single radio MLDs includes MLDs that support Enhanced Multi-Link Single Radio (MLSR) (eMLSR). eMLSR MLD devices generally operate one main wireless radio that can transmit and/or receive data frames on a given link, but can detect some data (e.g., short initial frames) on a set of other links when the device is not actively transmitting or receiving. Multi-radio MLDs may generally be classified into the following two types: (i) simultaneous transmission and reception (STR) MLD and (ii) non-STR MLD. For STR MLDs, a transmission on one link may not affect the operations of frame reception and clear channel assessment (CCA) on other links. Stated differently, for STR MLDs, individual links can operate independently of each other. For non-STR MLDs, operation on one link may be restricted by operation on another link. For example, a transmission on one link may not be allowed if it will cause reception interruption on another link. In another example, a reception or CCA on one link may not be allowed if a transmission is ongoing on another link.

Referring back to FIG. 1, in certain embodiments, the AP MLDs 120 may be controlled or managed at least partially by the controller 130. Here, the controller 130 couples to and provides coordination and control for the AP MLDs 120 1-3. For example, the controller 130 may handle adjustments to radio frequency (RF) power, channels, authentication, and security for the AP MLDs 120. The controller 130 may also coordinate the links formed by the AP MLDs 120. Each AP MLD 120 may maintain a respective connection to the DS 140, which may be configured to manage client roaming across multiple AP MLDs within the SMD 170 and/or ESS 160. In certain embodiments, the DS 140 may include or otherwise be implemented by the controller 130.

The operations of the controller 130 may be implemented by any device or system, and may be combined or distributed across any number of systems. For example, the controller 130 may be a wireless local area network (WLAN) controller for the deployment of AP MLDs 120 within the system 100. In some examples, the controller 130 is included within or integrated with an AP MLD 120 and coordinates the links formed by that AP 120 (or otherwise provides control for that AP MLD). For example, each AP MLD 120 may include a controller that provides control for that AP MLD. In some embodiments, the controller 130 is separate from the AP MLDs 120 and provides control for those AP MLDs. In FIG. 1, for example, the controller 130 may communicate with the AP MLDs 120 1-3 via a (wired or wireless) backhaul. The AP MLDs 120 1-3 may also communicate with one another, e.g., directly or indirectly via a wireless or wireline backhaul. The database(s) 172 are representative of storage systems that may include, without limitation, radio resource configurations and radio resource management (RRM) information, among other information.

In certain embodiments, the system 100 is representative of a seamless roaming architecture. Within system 100, seamless roaming is enabled within the SMD 170. The SMD 170 includes multiple AP MLDs 120 across which seamless roaming is supported, extending the fast basic service set (BSS) transition (FT) mobility domain (MD) defined in Institute of Electrical and Electronics Engineers (IEEE) 802.11r. As noted, in certain embodiments, an SMD 170 covers all AP MLDs of an ESS (e.g., ESS 160). In other embodiments, the ESS 160 may include multiple SMDs.

In certain embodiments, each SMD (e.g., SMD 170) is uniquely identified in the ESS 160 with a virtual MAC address, referred to herein as an SMD MAC address (or SMD identifier). Each AP MLD 120 may be configured with the identifier of the SMD (e.g., SMD MAC address) that the AP MLD 120 belongs to. In FIG. 1, for example, AP MLDs 120 1-3 may each be configured with the SMD MAC address associated with SMD 170. The respective APs 115 associated with each AP MLD 120 may advertise SMD information (for that AP MLD 120) in beacon and probe response frames transmitted by the APs 115.

In certain embodiments, the SMD 170 defines a single security domain where all AP MLDs 120 within the SMD 170 are trusted (and in the same ESS 160). In such embodiments, a STA MLD 110 can establish a single secure association with this trusted security domain, and all AP MLDs 120 of the SMD 170 can be configured to have the same set of cryptographic encryption key (e.g., same set of cipher suites, authentication and key management (AKM) suites, security capabilities, etc.). To achieve seamless roaming, the STA MLD 110 (or non-AP MLD) can initially associate with the SMD 170 through one of the AP MLDs 120 (e.g., within the SMD 170). As shown in FIG. 1, the STA MLD 110 may associate with the SMD 170 through AP MLD 120-1. Here, the STA MLD 110 initially connects to AP 120-1 through two links: link 1 and link 2. Link 1 connects STA 105-1 to AP 115-1, and link 2 connects STA 105-2 to AP 115-2.

For seamless roaming, the STA MLD 110 maintains its association and security context associated with the SMD 170 as it roams within the SMD 170, e.g., to avoid reauthentication, reassociation, and rekeying delays. As the STA MLD 110 moves away from AP MLD 120-1, the STA MLD 110 may roam to one or more other AP MLDs 120 2-3. For example, as the STA MLD 110 moves towards AP MLD 120-2, the STA MLD 110 may intend to establish (or add) two new links: link 3 between STA 105-1 and AP 115-3 and link 4 between STA 105-2 and AP 115-4. The STA MLD 110 may add links 3 and 4 while remaining associated with the SMD 170, thus facilitating seamless roaming of the STA MLD 110 among the AP MLDs 120 within the SMD 170.

While FIG. 1 illustrates an example in which seamless roaming is facilitated when the STA MLD 110 has reliable connection with its serving AP MLD (e.g., AP MLD 120-1), which can facilitate seamless roaming preparation for a target AP MLD (e.g. AP MLD 120-2 through its serving AP MLD), such reliable connection may not always be available in certain scenarios. In particular, scenarios may arise in which the STA MLD 110 attempts to roam directly to a target AP MLD (e.g., AP MLD 120-2 or 120-3) without having previously performed roaming preparation through a serving AP MLD within the SMD 170. For example, this scenario may happen because the STA MLD 110 does not have a reliable connection with the STA MLD's serving AP MLD due to a sudden drop in the STA MLD's received signal strength indication (RSSI) and hence the STA MLD has to roam directly to a target AP MLD. In these scenarios, the target AP MLD may lack sufficient context to identify and authenticate the STA MLD 110, determine an appropriate security association, and/or securely complete the roaming operation, especially in multi-link environments supporting different keying models and protected management frame settings.

For example, in shared PTK scenarios, if a pre-roaming preparation was not performed with the target AP MLD, then the STA MLD 110 may not be able to roam directly to the target AP MLD using a protected management frame (PMF), since the target AP MLD may not have any information on the STA MLD 110 and may not have knowledge of the serving AP MLD from where to fetch information associated with the STA MLD 110.

In other examples, in per-AP MLD PTK cases, if the target AP MLD uses a different PTK than the serving AP MLD and if a pre-roaming preparation was not performed with the target AP MLD, then the STA MLD 110 may have to first establish a new PTK with the target AP MLD and perform link setup with the target AP MLD before the STA MLD 110 is able to roam directly to the target AP MLD.

Certain embodiments described herein provide techniques, systems, and apparatus for improved seamless roaming of a STA MLD 110 when initiating roaming directly with a target AP MLD 120. For example, in certain embodiments, techniques are provided that enable a STA MLD 110 to securely roam between AP MLD 120s within an SMD 170 by exchanging management frames that carry parameters usable by a target AP MLD 120 to determine and apply an appropriate PTKSA, without relying on mandatory pre-roaming coordination through a serving AP MLD 120. The disclosed techniques support multiple roaming models, including roaming using a single PTK shared across the SMD 170, roaming using a PTK specific to the target AP MLD 120, and roaming in which a combined roaming exchange establishes a new PTK without separate roaming preparation and roaming execution phases.

By enabling the target AP MLD 120 to map addresses or identifiers received in roaming-related frames to PTKSA for the client, verify message integrity over encrypted and unencrypted frame portions, and selectively establish (or derive) cryptographic keys, the disclosed techniques provide a significant improvement to wireless network operation. These improvements can reduce roaming latency, lower signaling overhead, and enhance security robustness in multi-link wireless network environments, thereby improving the performance and operation of wireless communication systems.

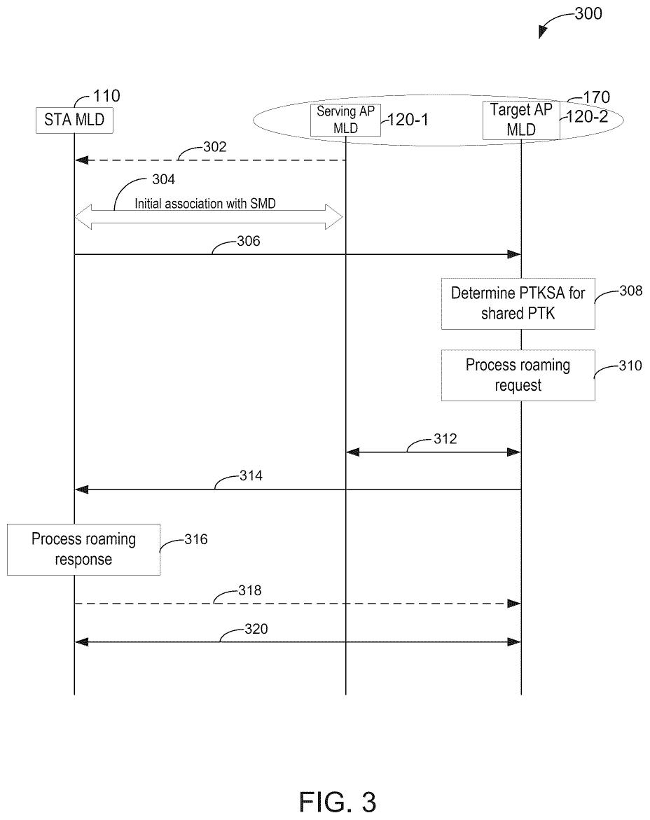

FIG. 3 illustrates a call flow diagram 300 for seamless roaming within an SMD 170 in which a single PTK is shared across multiple AP MLDs 120 of the SMD 170, according to certain embodiments.

At 302, one or more AP MLDs of the SMD 170, including the serving AP MLD (e.g., AP MLD 120-1), advertise SMD-related capability information. In the illustrated example, the advertised information may indicate that the network supports seamless roaming using a shared PTK across the SMD 170. Such advertisements may be included in beacon frames, probe response frames, (re)association response frames, or other management frames transmitted by the AP MLDs, and may enable the STA MLD 110 to determine that roaming can be performed without establishing a new PTK for each AP MLD.

In addition to advertising support for roaming using a shared PTK across the SMD 170, the AP MLDs in the SMD 170 may advertise support for a signaling key-based roaming option in which a signaling key (other than the shared PTK) is generated and used to protect roaming related exchanges. For example, the advertised capability information may indicate that the AP MLDs in the SMD 170 support an option in which a roaming request frame and a roaming response frame are protected using a signaling key different from the shared PTK, such as a signaling key derived from security context established during initial association with the SMD 170. The signaling key (or a roaming key) may be generated at the time of association with the SMD management entity (SMD-ME) and is an SMD level key, meaning the signaling key is used across all AP MLDs in the SMD 170 for that STA MLD 110. Advertising support for this option may enable the STA MLD 110 to determine that roaming may be performed using identifier-based signaling and signaling key protection, rather than PMF protection using the shared PTK. For example, the STA MLD 110 may choose to send a roaming request frame that includes an encrypted portion encrypted using the shared PTK or encrypted using a signaling key established at the time of initial association with the SMD (e.g., based on the shared PTK or a common SMD level pairwise master key (PMK)), based on the encrypted option supported by the AP MLD.

At 304, the STA MLD 110 performs an initial association with the SMD 170 (e.g. with an SMD-ME in the SMD 170) via a serving AP MLD (e.g., AP MLD 120-1). Through this initial association, the STA MLD 110 may establish security context associated with the SMD 170, including cryptographic material usable for subsequent secure communications within the SMD 170. In certain embodiments, the initial association may establish a trusted security association that enables the STA MLD 110 to roam between AP MLDs of the SMD 170 without reauthentication and reassociation.

At 306, the STA MLD 110 transmits a roaming request frame directly to the target AP MLD. The roaming request frame may include one or more parameters associated with seamless roaming within the SMD 170, such as a roaming MAC address, a STA MAC address, a non-AP MLD MAC address or another identifier usable by the target AP MLD to identify the STA MLD 110 and determine an applicable security association for the shared PTK. The roaming request may include an identifier (e.g. an MLD MAC address) for the serving AP MLD to enable the target AP MLD to fetch context from the serving AP MLD.

In certain embodiments, the roaming request frame is transmitted as a protected management frame (PMF) that is cryptographically protected (e.g. encrypted) using the shared PTK. In some such embodiments, the roaming request frame may include a transmitter address in a header of the roaming request frame that identifies the STA MLD 110 to the target AP MLD. In some embodiments, the transmitter address may be a one-time use randomized roaming MAC address. The PMF protection may enable the target AP MLD to authenticate the roaming request and verify message integrity using the shared PTK. In certain embodiments, the roaming request frame may include one or more additional parameters associated with seamless roaming within the SMD, such as identifiers and capability information, as illustrative examples, while still being protected as a PMF. The roaming request frame may be transmitted directly to the target AP MLD without performing a roaming preparation procedure via the serving AP MLD.

Note in embodiments in which the roaming request frame is transmitted as a PMF, the cryptographic protection applied to the frame may not encrypt all portions of the frame (e.g., a subset of the frame may be cryptographically protected). In particular, the transmitter address included in the header of the roaming request frame may be transmitted in the clear, such that the transmitter address is not encrypted even though the roaming request frame is PMF protected. This allows the target AP MLD to identify the STA MLD 110 based on the transmitter address and map the transmitter address to an appropriate PTKSA, while still benefitting from cryptographic integrity protection applied to other portions of the roaming request frame.

In certain embodiments, instead of transmitting the roaming request frame as a PMF, the STA MLD 110 may transmit a roaming request frame that includes one or more identifiers usable to identify the STA MLD 110 within the SMD 170. In some such embodiments, the roaming request frame may include a client identifier, such as a pairwise master key identifier (PMKID), a non-AP MLD identifiable random medium access control (MAC) address (IRM), a roaming non-AP MLD MAC address (also referred to as a roaming MAC address) or a combination thereof. The PMKID may be carried in a robust security network element (RSNE) included in the roaming request frame. The non-AP MLD IRM and/or the roaming non-AP MLD MAC address may be carried in a multi-link (ML) element (e.g., a basic ML element or another element/field) of the roaming request frame. In certain embodiments, the client identifier is designated for one-time use.

The roaming request frame may include an unencrypted portion carrying the client identifier (e.g., in RSNE or ML element), and in some embodiments, an encrypted portion carrying additional roaming relayed parameters. The encrypted portion may be encrypted using the shared PTK or using a signaling key that is established at the time of initial association with the SMD (e.g., based on shared PTK or shared PMK). As noted, the STA MLD 110 may determine to use the shared PTK or the signaling key based on a capability of the target AP MLD. The encrypted cipher text generated for the roaming request frame may replace the content of the roaming request frame after the fields and elements that are sent in the clear in the roaming request frame. In such embodiments, the roaming request frame may be transmitted without PMF protection while still enabling the target AP MLD to securely identify the STA MLD 110 and protecting most of the contents of the roaming request, thereby providing better security and privacy.

In certain embodiments, the roaming request frame transmitted at 306 may further include a message integrity check (MIC) (or MIC parameter) generated by the STA MLD 110 using the shared PTK associated with the SMD 170. The MIC may be calculated over at least a portion of one or more elements or fields of the roaming request frame, such as elements carrying client identifiers or roaming related parameters, and may additionally incorporate additional authentication data (AAD) that is not encrypted but is authenticated by the MIC. Including such a MIC enables the target AP MLD to verify possession of the shared PTK by the STA MLD 110, even when the roaming request frame is not transmitted as a PMF. This MIC incorporation may be particularly advantageous in embodiments that employ signaling key-based roaming where a signaling key is used for protecting the roaming request, as the MIC provides an explicit cryptographic confirmation that both the STA MLD 110 and the target AP MLD possess the same shared PTK prior to completing the roaming operation. In certain embodiments, the MIC may be generated using the signaling key.

In other certain embodiments, the unencrypted portion of the roaming request frame may include (i) a client identifier (e.g., a PMKID, a non-AP MLD IRM, a roaming MLD MAC address, etc.), (ii) an identifier of the serving AP MLD (e.g., AP MLD 120-1) (e.g., a MAC address or AP MLD identifier), (iii) a packet number (PN) used for replay protection and/or the encrypted portion, and (iv) a MIC generated by the STA MLD 110 using the shared PTK over at least a portion of the roaming request frame and, in some embodiments, over one or more AAD fields). In some such embodiments, the encrypted portion of the roaming request frame may include parameters related to link setup, context transfer, or other roaming related information. Partial encryption of the roaming request frame may provide improved privacy while still allowing the target AP MLD to identify the STA MLD 110 and perform initial validation. In certain embodiments, the roaming request frame may be implemented with (or similar to) a link reconfiguration request frame.

Additionally, note in certain embodiments, upon receiving roaming request frames (such as at 306), the target AP MLD may apply one or more rate-limiting or admission control rules to mitigate potential denial-of-service (DoS) attacks and/or excessive signaling. For example, the target AP MLD may limit a number of roaming request frames processed within a time window, prioritize roaming requests received from STA MLDs associated with the SMD 170, and/or defer or terminate processing of roaming requests that do not satisfy predefined criteria. Such rules may be applied prior to or in conjunction with cryptographic processing of the roaming request frame, thereby reducing unnecessary consumption of processing and/or cryptographic resources while maintaining secure roaming operation.

At 308, the target AP MLD determines a PTKSA corresponding to the STA MLD that includes a shared PTK. In certain embodiments, determining the PTKSA may include mapping one or more parameters included in the roaming request frame, such as a transmitter address or other client identifier (e.g., PMKID, non-AP MLD IRM, the roaming non-AP MLD MAC address or a roaming MAC address), to a PTKSA (that includes shared PTK) for the STA MLD 110. In certain embodiments, the target AP MLD may obtain the PTKSA with the shared PTK associated with the SMD 170 from a computing system, which is representative of a controller (e.g., controller 130, such as a wireless local area network controller (WLC)), key management system (e.g., network key store), or other network side entity that maintains cryptographic material for the SMD 170. In other embodiments, the PTKSA with shared PTK may already be locally available to the target AP MLD, e.g. when the PTKSA (with shared PTK) was provided to the target AP MLD earlier as part of preparing target AP MLDs with static roaming context for the STA MLD. In some embodiments, the target AP MLD may also determine the pairwise master key security association (PMKSA) for the STA MLD 110 that may include an SMD level PMK and an SMD level signaling key (e.g. an SMD level roaming key), which gets used for encrypting roaming request sent directly to a target AP MLD.

Note, in some cases, the PTKSA with the shared PTK for a STA MLD may be provided to multiple neighboring AP MLDs within the SMD 170, for example, via a computing system (e.g., controller, key management system, etc.). At this stage, however, the shared PTK may not be installed in hardware of the target AP MLD. Because there may be a large number of shared PTKs corresponding to a large number of STA MLDs that are associated to the SMD that may be distributed to multiple AP MLDs within the SMD 170, installing the shared PTK for a STA MLD in hardware on all such AP MLDs prior to a successful roam could lead to excessive (or at least increased) consumption of hardware key resources. Instead, in certain embodiments, the target AP MLD may retain the shared PTK in software memory and use the shared PTK to process the roaming request frame, such as verifying protected management frame integrity, decrypting the frame and generating an encrypted roaming response, without performing hardware installation at this time.

In embodiments in which a signaling key-based option is supported, the same client identifier may additionally be used to map to a signaling key distinct from the shared PTK. In this manner, the client identifier enables the target AP MLD to determine the appropriate security context for processing the roaming request frame. In this case, the signaling key (or a roaming key), which is an SMD level key (i.e. used across all AP MLDs in the SMD for the STA MLD), can be stored as part of a PMKSA or PTKSA.

At 310, the target AP MLD processes the roaming request frame using the determined security association (e.g., PTKSA corresponding to the shared PTK or signaling key). Processing the roaming request frame may include decrypting at least a portion of the frame, verifying message integrity information and/or determining whether the roaming request frame satisfies security and policy specifications for accepting the roam for STA MLD 110.

In certain embodiments, the target AP MLD decrypts encrypted portions of the roaming request frame using either the shared PTK or the signaling key, depending on the advertised roaming option. Such cryptographic processing may be performed in software and may not involve installation of the shared PTK or signaling key in hardware at this stage. If the roaming request frame includes a MIC generated by the STA MLD 110 using the shared PTK, the target AP MLD may verify the MIC using the shared PTK over the corresponding elements or fields of the roaming request frame and any associated AAD. If MIC verification fails, the roaming operation may be deemed unsuccessful, and the target AP MLD may generate and transmit a roaming failure response. If MIC verification succeeds, then the target AP MLD may determine that the STA MLD 110 possesses the correct shared PTK and may proceed with the roaming operation.

In other embodiments in which the roaming request frame is partially encrypted and includes a PN among other parameters, the processing of the roaming request frame by the target AP MLD may include verifying the identity of the STA MLD 110 and the STA MLD's association with the SMD 170, performing replay validation using the PN included in the roaming request frame, verifying the MIC included in the roaming request frame using the shared PTK to confirm possession of the same PTK by the STA MLD 110, and upon successful MIC verification, decrypting the encrypted portion of the roaming request frame using the shared PTK and/or PN. Additionally, in certain embodiments, the target AP MLD may also generate a new MIC for use in the roaming response frame. If any validation fails (e.g., replay detection and/or MIC verification failure), then the roaming request frame may be rejected.

At 312, after successful processing of the roaming preparation request frame, the target AP MLD may fetch a client context associated with the STA MLD 110 from the serving AP MLD. The fetched context may include a security context, link configuration information, session parameters, and other state information that can be used to support roaming of the STA MLD 110 to the target AP MLD. In certain embodiments, the target AP MLD, at 312, may initiate an update to a distribution system (e.g., DS 140) mapping, for example, to associate the STA MLD 110 with the target AP MLD for subsequent data forwarding.

In certain embodiments, in response to determining that the roaming request frame is successfully processed and that roaming of the STA MLD 110 to the target AP MLD is successful, the target AP MLD may install the shared PTK in hardware of the target AP MLD. Installing the shared PTK in hardware may enable subsequent frame exchanges (e.g., management and data frames) with the STA MLD 110 to be performed efficiently using hardware-accelerated cryptographic processing.

At 314, the target AP MLD generates and transmits a roaming response frame to the STA MLD 110. In certain embodiments, the roaming response frame indicates whether the roaming request was successful. Additionally, in certain embodiments, the roaming response frame may be a PMF protected using the shared PTK or the signaling key corresponding to the STA MLD 110.

In certain embodiments in which the roaming request frame includes a MIC and MIC verification is successful, the roaming response frame may include another MIC generated by the target AP MLD using the shared PTK, calculated over one or more elements or fields of the roaming response frame and optionally AAD. The roaming response frame may further include one or more updated client identifiers, such as one or more updated PMKIDs or one or more updated roaming non-AP MLD MAC addresses, as illustrative examples, for use in subsequent roaming operations. In certain embodiments, the client identifiers provided are one-time use only for subsequent roaming and a new identifier is provided as part of the subsequent roam exchange.

In certain embodiments, one or more elements or fields of the roaming response frame may be encrypted using the shared PTK or the signaling key, while selected header fields may remain unencrypted. Encrypting the roaming response frame in this manner enhances privacy and security while allowing the STA MLD 110 to correctly receive and process the response.

In other certain embodiments, the roaming response frame may be partially encrypted using the shared PTK. In such embodiments, the roaming response frame may include, in an unencrypted portion, (i) the client identifier, (ii) the identifier of the serving AP MLD, (iii) a PN used for replay protection and/or the encrypted portion, and (iv) the MIC (or MIC parameter) generated by the target AP MLD using the shared PTK). The roaming response frame may include, in an encrypted portion, parameters related to link setup, context transfer, PN used for encryption, or other roaming related information. In certain embodiments, the roaming response frame may be implemented with (or similar to) a link reconfiguration response frame.

At 316, upon receiving the roaming response frame, the STA MLD 110 may decrypt the encrypted portions of the roaming response frame using the shared PTK or the signaling key, as applicable, and verify the MIC included in the roaming response frame. If MIC verification fails, then the roaming operation may be deemed unsuccessful. If MIC verification succeeds, then the STA MLD 110 may determine that the roaming operation has been successfully completed and that both the STA MLD 110 and the target AP MLD possess the same shared PTK.

At 318, the STA MLD 110 may optionally transmit a roaming confirmation frame to the target AP MLD to confirm completion of the roaming operation. In certain embodiments, the roaming confirmation frame may be transmitted as a PMF protected using the shared PTK or the signaling key corresponding to the STA MLD 110. In other embodiments, the roaming confirmation frame may be partially encrypted using the shared PTK or the signaling key. The roaming confirmation frame may indicate that the STA MLD 110 is ready to exchange data frames with the target AP MLD using the shared PTK.

In other embodiments, the roaming confirmation frame may be omitted and roaming may be considered successful upon successful processing of the roaming response frame.

At 320, the STA MLD 110 and the target AP MLD may exchange data frames (e.g., downlink (DL) and/or uplink (UL) data frames) with each other. The data exchange may be protected using the shared PTK.

As used herein, a PMF generally refers to a management frame or action frame that includes cryptographic protection to provide encryption and message integrity and origin authentication. In some embodiments, a PMF is generated by computing a MIC over at least a portion of the management frame using a cryptographic key associated with a security context between a STA and a network entity, such as a PTK or another signaling key. The resulting MIC may be included in the management frame and verified by a receiving device to detect modification and/or spoofing of the frame. While a PMF may include encryption and integrity protection for selected portions of the frame, other portions of the frame, such as addressing fields included in a frame header, may remain unencrypted and transmitted in the clear, but these fields may be included in MIC generation for integrity protection.

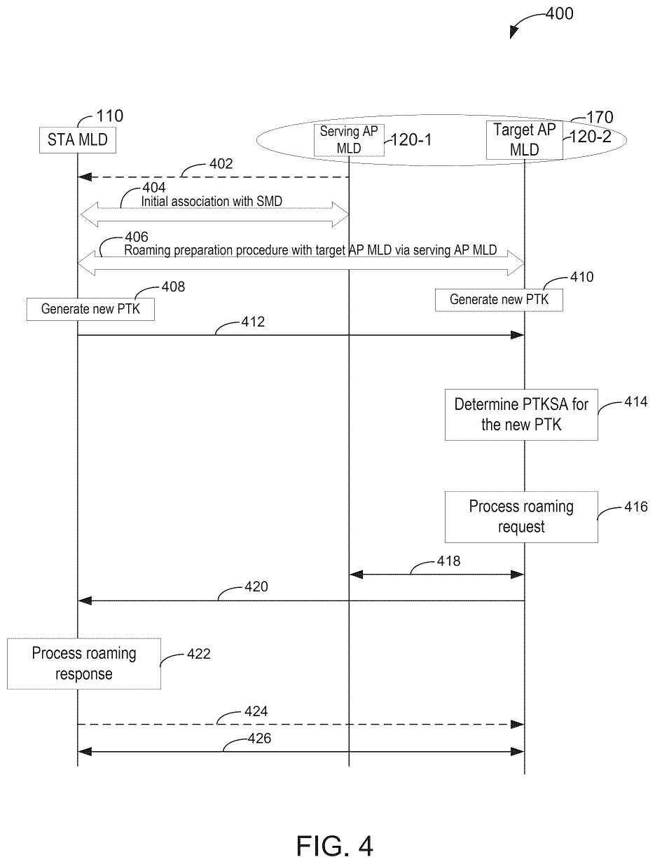

FIG. 4 illustrates a call flow diagram 400 for seamless roaming within an SMD 170 in which a different PTK is generated for each AP MLD 120 of the SMD 170, according to certain embodiments. In call flow diagram 400, a new PTK for a target AP MLD (e.g., AP MLD 120-2) may be generated prior to roaming based on a roaming preparation procedure performed via a serving AP MLD (e.g., AP MLD 120-1).

At 402, one or more AP MLDs of the SMD 170, including the serving AP MLD (e.g., AP MLD 120-1), advertise SMD-related capability information. In the illustrated example, the advertised information may indicate that the network supports seamless roaming using a different PTK for each AP MLD within the SMD 170 (generally referred to herein as “per AP MLD PTK operation”). Such advertisements may be included in beacon frames, probe response frames, (re)association response frames, or other management frames transmitted by the AP MLDs, and may enable the STA MLD 110 to determine that roaming to different AP MLDs within the SMD 170 involves use of different PTKs.

In addition to advertising support for roaming using a per AP MLD PTK in the SMD 170, the target AP MLD may advertise support for a signaling key-based roaming option (or direct roaming with a target AP MLD) in which a signaling key (or a roaming key) is generated and used to protect roaming related exchanges sent directly to a target AP MLD. For example, the advertised capability information may indicate that the target AP MLD supports an option in which a roaming request frame and a roaming response frame are protected using a signaling key different from the new PTK, such as a signaling key derived from security context established during initial association with the SMD 170. Advertising support for this option may enable the STA MLD 110 to determine that roaming may be performed using signaling key-based roaming option and using signaling key protection, rather than PMF protection using the PTK associated with the target AP MLD. For example, the STA MLD 110 may choose to send a roaming request frame that includes an encrypted portion encrypted using the PTK associated with the target AP MLD or encrypted using a signaling key established at the time of initial association with the SMD (e.g., based on the PTK or PMK), based on the encrypted option supported by the AP MLD. In certain embodiments, a wireless communication specification (e.g., 802.11 amendment) may define that a signaling key is used for protecting roaming exchange sent directly to a target AP MLD without explicitly advertising support for signaling key-based roaming option.

At 404, the STA MLD 110 performs an initial association with the SMD 170 via a serving AP MLD (e.g., AP MLD 120-1). Through this initial association, the STA MLD 110 may establish security context associated with the SMD 170, including cryptographic material usable for subsequent secure communications within the SMD 170. In certain embodiments, the initial association may establish a trusted security association that enables the STA MLD 110 to roam between AP MLDs of the SMD 170 without full reauthentication and reassociation.

At 406, prior to initiating roaming to the target AP MLD, the STA MLD 110 may perform a roaming preparation procedure with the target AP MLD via the serving AP MLD. The roaming preparation procedure may involve exchange of roaming preparation request and response signaling that enables generation of cryptographic material for use during subsequent roaming.

At 408 and 410, as a result of the roaming preparation procedure, a new PTK specific to the target AP MLD is generated. In certain embodiments, the STA MLD 110 may generate the new PTK at 408 and the target AP MLD may independently generate or derive the same new PTK at 410, such that both the STA MLD 110 and target AP MLD possess the new PTK prior to execution of the roaming operation.

At 412, the STA MLD 110 transmits a roaming request frame to the target AP MLD. The roaming request frame may include one or more parameters associated with seamless roaming within the SMD 170, such as an address or identifier usable by the target AP MLD to identify the STA MLD 110 and determine an applicable security association for the STA MLD 110.

In certain embodiments, the roaming request frame is transmitted as a PMF that is cryptographically protected using the new PTK. In some such embodiments, the roaming request frame may include a transmitter address in a header of the roaming request frame that identifies the STA MLD 110 to the target AP MLD, e.g., the transmitter address may be set to a randomized roaming MAC address or a STA MAC address. The PMF protection may enable the target AP MLD to authenticate the roaming request and verify message integrity using the new PTK. In certain embodiments, the roaming request frame may include one or more additional parameters associated with seamless roaming within the SMD 170, such as identifiers and capability information for STA MLD 110, as illustrative examples, while still being protected as a PMF. The roaming request frame may be transmitted directly to the target AP MLD after performing a roaming preparation procedure via the serving AP MLD.

In certain embodiments, instead of transmitting the roaming request frame as a PMF, the STA MLD 110 may transmit a roaming request frame that includes one or more identifiers usable to identify the STA MLD 110. In some such embodiments, the roaming request frame may include a client identifier, such as a PMKID, a non-AP MLD IRM, a roaming non-AP MLD MAC address, or a combination thereof. The PMKID may be carried in a RSNE included in the roaming request frame. The non-AP MLD IRM and/or the roaming non-AP MLD MAC address may be carried in a ML element (e.g., a basic ML element or another element/field) of the roaming request frame or in the transmitter address in the header. In certain embodiments, the client identifier is designated for one-time use.

The roaming request frame may include an unencrypted portion carrying the client identifier (e.g., RSNE or ML element), and in some embodiments, an encrypted portion carrying additional roaming related parameters. The encrypted portion may be encrypted using the new PTK or using a signaling key that is established at the time of initial association of the STA MLD 110 with the SMD 170. As noted, the STA MLD 110 may determine to use the new PTK or the signaling key based on the related capability announced by the target AP MLD or based on a procedure defined in a wireless communication standard (e.g., 802.11 amendment). The encrypted cipher text generated for the roaming request frame may replace the content of the roaming request frame after the fields and elements that are sent in the clear in the roaming request frame. In such embodiments, the roaming request frame may be transmitted without PMF protection while still enabling the target AP MLD to securely identify the STA MLD 110.

In certain embodiments, the roaming request frame transmitted at 412 may further include a MIC generated by the STA MLD 110 using the new PTK associated with the target AP MLD. The MIC may be calculated over at least a portion of one or more elements or fields of the roaming request frame, such as elements carrying client identifiers or roaming related parameters, and may additionally incorporate AAD that is not encrypted but is authenticated by the MIC. Including such a MIC enables the target AP MLD to verify possession of the new PTK by the STA MLD 110, even when the roaming request frame is not transmitted as a PMF. This MIC incorporation may be particularly advantageous in embodiments that employ signaling key for protection of the roaming request, as the MIC provides an explicit cryptographic confirmation that both the STA MLD 110 and the target AP MLD possess the same new PTK prior to completing the roaming operation.

Additionally, note in certain embodiments, upon receiving roaming request frames (such as at 412), the target AP MLD may apply one or more rate-limiting or admission control rules to mitigate potential DoS attacks and/or excessive signaling. For example, the target AP MLD may limit a number of roaming request frames processed within a time window, prioritize roaming requests received from STA MLDs associated with the SMD 170, and/or defer processing of roaming requests that do not satisfy predefined criteria. Such rules may be applied prior to or in conjunction with cryptographic processing of the roaming request frame, thereby reducing unnecessary consumption of processing and/or cryptographic resources while maintaining secure roaming operation.

At 414, the target AP MLD determines a PTKSA corresponding to the new PTK. In certain embodiments, determining the PTKSA may include mapping one or more parameters included in the roaming request frame, such as a transmitter address or other client identifier (e.g., PMKID, non-AP MLD IRM, and/or the roaming non-AP MLD MAC address), to a PTKSA associated with the new PTK for the target AP MLD. In certain embodiments, determining the PTKSA may also include accessing the PMKSA for getting access to the signaling key to decrypt and process the roaming request frame.

In embodiments in which a signaling key based option is supported, the same client identifier may additionally be used to map to a signaling key distinct from the new PTK. In this manner, the client identifier enables the target AP MLD to determine the appropriate security context for processing the roaming request frame.

At 416, the target AP MLD processes the roaming request frame using the determined security association (e.g., PTKSA corresponding to the new PTK or the signaling key). Processing the roaming request frame may include decrypting at least a portion of the frame, verifying message integrity information and/or determining whether the roaming request frame satisfies security and policy specifications for accepting the STA MLD 110. In certain embodiments, cryptographic processing at this stage may be performed in software, and the new PTK may not yet be installed in hardware.

In certain embodiments, the target AP MLD decrypts encrypted portions of the roaming request frame using either the new PTK or the signaling key, depending on the advertised roaming option or roaming option defined in the amendment. If the roaming request frame includes a MIC generated by the STA MLD 110 using the new PTK, the target AP MLD verifies the MIC using the new PTK over the corresponding elements or fields of the roaming request frame and any associated AAD. If MIC verification fails, the roaming operation may be deemed unsuccessful, and the target AP MLD may generate and transmit a roaming failure response. If MIC verification succeeds, then the target AP MLD may determine that the STA MLD 110 possesses the correct new PTK and may proceed with the roaming operation.

At 418, after successful processing of the roaming preparation request frame, the target AP MLD may fetch a client context associated with the STA MLD 110 from the serving AP MLD. The fetched context may include a security context, link configuration information, session parameters, and other state information that can be used to support roaming of the STA MLD 110 to the target AP MLD. In one embodiment, the target AP MLD may perform fetching of the context from the serving AP MLD as part of processing the roaming preparation request, since it may have to verify the client identifier and the SMD association of the client with the serving AP MLD, Thus, in some embodiments, steps 416 and 418 may be combined.

At 420, the target AP MLD generates and transmits a roaming response frame to the STA MLD 110. In certain embodiments, the roaming response frame indicates whether the roaming request was successful (e.g., success or failure for the roaming request). Additionally, in certain embodiments, the roaming response frame may be a PMF protected using the new PTK or signaling key corresponding to STA MLD 110.

In certain embodiments in which the roaming request frame includes a MIC and MIC verification is successful, the roaming response frame may include another MIC generated by the target AP MLD using the new PTK, calculated over one or more elements or fields of the roaming response frame and optionally AAD. The roaming response frame may further include one or more updated client identifiers, such as one or more updated PMKIDs or one or more updated roaming non-AP MLD MAC addresses (also referred to as roaming MAC address(es)), as illustrative examples, for use in subsequent roaming operations.

In certain embodiments, one or more elements or fields of the roaming response frame may be encrypted using the new PTK or the signaling key, while selected header fields may remain unencrypted. Encrypting the roaming response frame in this manner enhances privacy and security while allowing the STA MLD 110 to correctly receive and process the response.

At 422, upon receiving the roaming response frame, the STA MLD 110 may decrypt the encrypted portions of the roaming response frame using the new PTK or the signaling key, as applicable, and verify the MIC included in the roaming response frame. If MIC verification fails, then the roaming operation may be deemed unsuccessful. If MIC verification succeeds, then the STA MLD 110 may determine that the roaming operation has been successfully completed and that both the STA MLD 110 and the target AP MLD possess the same new PTK.

At 424, the STA MLD 110 may optionally transmit a roaming confirmation frame to the target AP MLD to confirm completion of the roaming operation. In certain embodiments, the roaming confirmation frame may be transmitted as a PMF protected using the new PTK or signaling key corresponding to the STA MLD 110. In other embodiments, the roaming confirmation frame may be partially encrypted using the new PTK or the signaling key. The roaming confirmation frame may indicate that the STA MLD 110 is ready to exchange data frames with the target AP MLD using the new PTK.

At 426, the STA MLD 110 and the target AP MLD may exchange data frames (e.g., DL and/or UL data frames) with each other. The data exchange may be protected using the new PTK.

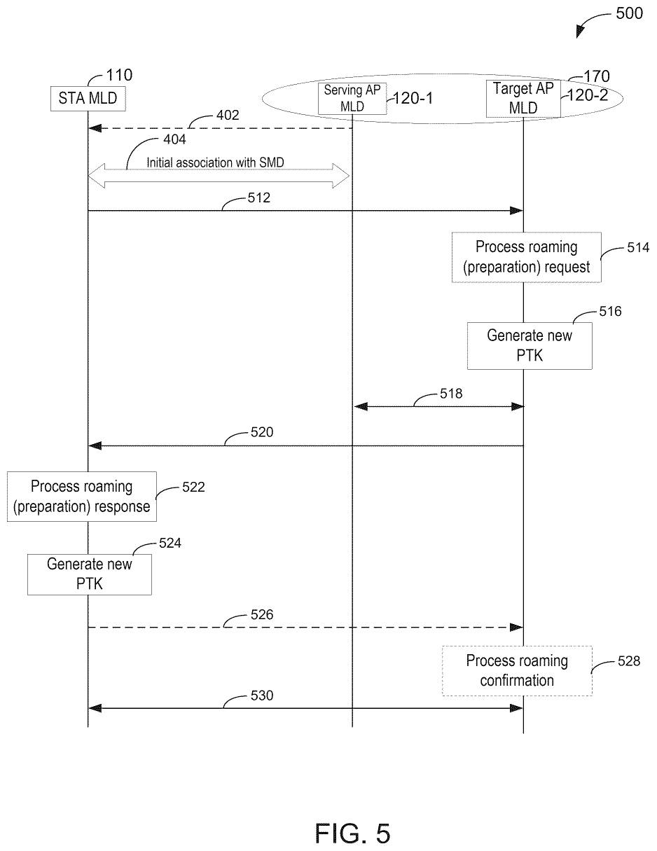

FIG. 5 illustrates a call flow diagram 500 for seamless roaming within an SMD 170 in which a different PTK is generated for each AP MLD 120 of the SMD 170, according to certain embodiments. In call flow diagram 500, a new PTK for a target AP MLD (e.g., AP MLD 120-2) is not generated prior to roaming, e.g., based on a roaming preparation procedure performed via a serving AP MLD (e.g., AP MLD 120-1). Steps 402 and 404 of the call flow diagram 500 may be similar to steps 402 and 404 of the call flow diagram 400 and are not repeated here for the sake of clarity.

Compared to the call flow diagram 400, in the call flow diagram 500, the STA MLD 110 has not performed a roaming preparation procedure with the target AP MLD 120-2 prior to roaming. As a result, a new PTK for the target AP MLD 120-2 has not yet been generated at the time roaming is initiated. The call flow diagram 500 may include an (i) exchange of a roaming request frame, a roaming response frame, and (optional) roaming confirmation frame or (ii) an exchange of a roaming preparation request frame, a roaming preparation response frame, and (optional) roaming confirmation frame.

At 512, the STA MLD 110 transmits a roaming (preparation) request frame to the target AP MLD. The roaming (preparation) request frame may include a client identifier usable to identify the STA MLD 110 (e.g., PMKID, non-AP MLD IRM, roaming MLD MAC address, or a roaming MAC address etc.) as well as one or more parameters that can be used for generating a new PTK at the target AP MLD. Such parameters may include a supplicant nonce (SNonce), Diffie-Hellman parameters including a Diffie-Hellman (DH) (ephemeral) public key (EPK) (or DH public key) corresponding to the STA MLD 110 (e.g., a supplicant ephemeral key (S_EPK)), RSNE, robust security network extension element (RSNXE), an identifier of the SMD 170 (SMD identifier) (or SMD element), or any combination thereof, as illustrative examples. In certain embodiments, the roaming (preparation) request frame may further include information indicating that link setup and context transfer are requested as part of the roaming operation. In certain embodiments, the roaming (preparation) request frame may be an enhanced version of a link reconfiguration request frame.

In certain embodiments, some or most elements or fields of the roaming (preparation) request frame may be encrypted using a signaling key (or a roaming key) that was established as part of the initial association of the STA MLD 110 with the SMD 170. Encrypting portions of the roaming (preparation) request frame using the signaling key can improve security and privacy while allowing selected identifiers to remain unencrypted for client identification. In certain embodiments, the roaming (preparation) request frame may be unencrypted.

At 514, the target AP MLD processes the roaming (preparation) request frame. This processing may include verifying the client identifier and the SMD association of the STA MLD 110 via the serving AP MLD, performing replay validation based on the client identifier (e.g., using a one-time identifier or token), and determining whether the roaming (preparation) request frame should be accepted. In certain embodiments, verification may involve communication with the serving AP MLD to confirm the STA MLD's association and to obtain security material associated with the STA MLD 110 (e.g., PMKSA, signaling key). If any validation fails (e.g., replay detection), then the roaming (preparation) request frame may be rejected. Processing the roaming (preparation) request frame may also include decrypting encrypted portions of the roaming (preparation) request frame using the signaling key and extracting parameters to be used for generation of a new PTK for the target AP MLD. In certain embodiments, the target AP MLD may obtain the PMKSA and/or the signaling key from a computing system, which is representative of a controller (e.g., controller 130, such as a wireless local area network controller (WLC)), key management system (e.g., network key store), or other network side entity that maintains cryptographic material for the SMD 170. In other embodiments, the PMKSA and/or the signaling key may already be locally available to the target AP MLD, e.g. when the PMKSA and the signaling key were provided to the target AP MLD earlier as part of preparing target AP MLDs with static roaming context for the STA MLD. In certain embodiments, the target AP MLD may also apply admission control or rate limiting rules when processing roaming requests to mitigate potential DoS attacks.

At 516, the target AP MLD generates a new PTK specific to the target AP MLD, based on the extracted parameters and the PMK associated with the STA MLD 110. In certain embodiments, the new PTK is generated using a key derivation function (KDF) that uses a combination of one or more of the PMK, nonces (e.g., authenticator nonce (ANonce), SNonce), MAC addresses (e.g., supplicant address (SPA), authenticator address (AA), AP MLD MAC address, etc.), SMD identifiers, and optionally Diffie-Hellman shared secret material (generated based on DH public keys of the STA MLD and the target AP MLD, such as S_EPK and authenticator ephemeral key (A_EPK), respectively). At this stage, the new PTK may be retained in software and may not yet be installed in hardware. In certain embodiments, the new PTK may be generated using one of the following Equations (1)-(8). Note, however, that Equations (1)-(8) are provided as reference examples and that the new PTK may use other key derivation functions.

New PTK=KDF−Hash−Length(PMK, “Seamless Roaming PTK”, SNonce∥ANonce∥SMD MAC Address∥AP MLD MAC Address∥SPA∥DHss) (1)

New PTK=KDF−Hash−Length(PMK, “Seamless Roaming PTK”, SNonce∥ANonce∥AP MLD MAC Address∥SPA∥DHss) (2)

New PTK=KDF−Hash−Length(PMK, “Seamless Roaming PTK”, SMD MAC Address∥Min(AA, SPA)∥Max(AA, SPA)∥Min(ANonce, SNonce)∥Max(ANonce, SNonce)∥DHss) (3)

New PTK=KDF−Hash−Length(PMK, “Seamless Roaming PTK”, Min(AA, SPA)∥Max(AA, SPA)∥Min(ANonce, SNonce)∥Max(ANonce, SNonce)∥DHss) (4)

New PTK=KDF−Hash−Length(PMK, “Seamless Roaming PTK”, SNonce∥ANonce∥SMD MAC Address∥AP MLD MAC Address∥SPA) (5)

New PTK=KDF−Hash−Length(PMK, “Seamless Roaming PTK”, SNonce∥ANonce∥AP MLD MAC Address∥SPA) (6)

New PTK=KDF−Hash−Length(PMK, “Seamless Roaming PTK”, SMD MAC Address∥Min(AA, SPA)∥Max(AA, SPA)∥Min(ANonce, SNonce)∥Max(ANonce, SNonce)) (7)

New PTK=KDF−Hash−Length(PMK, “Seamless Roaming PTK”, Min(AA, SPA)∥Max(AA, SPA)∥Min(ANonce, SNonce)∥Max(ANonce, SNonce)) (8)

Equations (1)-(4) employ a Diffie-Hellman shared secret (DHss) that is generated when DH parameters of the STA MLD 110 and target AP MLD are exchanged. Equations (5)-(8) do not employ a DHss for PTK generation, e.g., for cases when DH parameters are not exchanged between the STA MLD 110 and target AP MLD. In Equations (1)-(8), SPA may be the MAC address of the STA MLD 110 and the “Seamless Roaming PTK” label can be set to any other text for PTK generation. In Equations (3), (4), (7), and (8), AA may be the MAC address of the target AP MLD.

At 518, the target AP MLD fetches context associated with the STA MLD 110 from the serving AP MLD. The fetched context may include security context and roaming related context, such as information associated with link setup, traffic handling, and/or state maintained at the serving AP MLD. In certain embodiments, the target AP MLD may also initiate a distribution system mapping update as part of or in parallel with the context fetch. The target AP MLD may also set up links for the STA MLD 110.

At 520, the target AP MLD generates and transmits a roaming (preparation) response frame to the STA MLD 110. The roaming (preparation) response frame may include parameters usable by the STA MLD 110 to generate the same new PTK, such as an ANonce, Diffie-Hellman parameters corresponding to the target AP MLD (e.g., DH public key corresponding to the target AP MLD, such as an A_EPK), RSNE, RSNXE, and SMD-related identifiers (e.g., SMD identifier, SMD element, etc.), among others. Some or most elements or fields of the roaming (preparation) response frame may be encrypted using the signaling key (or roaming key). The roaming (preparation) response frame may also indicate parameters or status information associated with link setup and context transfer. In certain embodiments, the roaming (preparation) response frame may be unencrypted. In some such embodiments, the roaming (preparation) response frame may be an enhanced version of a link reconfiguration response frame.

In certain embodiments, the roaming (preparation) response frame may further include a MIC generated using the newly generated PTK over one or more elements or fields of the roaming (preparation) response frame and optionally one or more AAD fields. The roaming (preparation) response frame may also include one or more updated client identifiers, such as one or more updated PMKIDs or one or more updated roaming non-AP MLD MAC addresses, as illustrative examples, for use in subsequent roaming operations. In certain embodiments, the updated client identifier(s) may be included in an encrypted portion of the roaming (preparation) response frame.

At 522, upon receiving the roaming (preparation) response frame, the STA MLD 110 processes the roaming (preparation) response frame. Processing the roaming (preparation) response frame may include decrypting encrypted portions of the roaming (preparation) response frame using the signaling key, e.g., to obtain the parameters to be used for PTK generation at the STA MLD 110.

At 524, the STA MLD 110 uses the (decrypted) parameters included in the roaming (preparation) response frame to generate the new PTK corresponding to the target AP MLD. In embodiments in which the roaming (preparation) response frame is unencrypted, the new PTK may be generated using the ANonce/A_EPK received from the target AP MLD, the previously transmitted SNonce/S_EPK, and the common PMK. The STA MLD 110 may also verify the MIC included in the roaming (preparation) response frame using the newly generated PTK. If MIC verification fails, then the roaming operation is deemed unsuccessful and the STA MLD 110 may retry the roaming operation. If MIC verification succeeds, then the STA MLD 110 determines that both the STA MLD 110 and the target AP MLD possess the same newly generated PTK and that roaming to the target AP MLD has been successfully completed. Responsive to successful roaming, the STA MLD 110 may install the newly generated PTK for subsequent protected communications with the target AP MLD.

At 526, the STA MLD 110 may optionally transmit a roaming confirmation frame to the target AP MLD to confirm generation and possession of the new PTK. In such embodiments, the roaming confirmation frame may include a MIC generated using the newly generated PTK and optionally one or more AAD fields. In some embodiments, the roaming configuration frame may be PMF protected using the new PTK. In some such embodiments, the roaming confirmation frame may be an enhanced version of a link reconfiguration notification frame.

At 528, upon receiving the roaming confirmation frame, the target AP MLD may process the roaming confirmation frame, e.g., to verify the MIC using the new PTK. If verification succeeds, then the target AP MLD may determine that the roaming operation has been successfully completed. In these embodiments, the roaming exchange with the target AP may include an exchange of up to three frames (e.g., roaming (preparation) request frame, roaming (preparation) response frame, and (optional) roaming (preparation) confirmation frame). Note, in other embodiments, the roaming confirmation frame may be omitted, and the target AP MLD may determine roaming success based on receiving an acknowledgment from the STA MLD 110 of the roaming (preparation) response frame and/or based on successful verification of the MIC included in the roaming (preparation) response frame.

At 530, the STA MLD 110 and the target AP MLD may exchange data frames (e.g., DL and/or UL data frames) with each other. The data exchange may be protected using the new PTK.

Note, in one or more embodiments herein, the AAD fields may include one or more (or a combination of) the following parameters: PMKID, non-AP MLD MAC address (or another one-time use identifier for the non-AP MLD), AP MLD MAC address, SNonce, ANonce, Diffie-Hellman parameters (including DH public key), and other unencrypted elements/fields in the corresponding frame (e.g., roaming request frame, roaming response frame).

In certain embodiments, the elements/fields in the roaming request and roaming response frames (and possibly roaming confirmation frame) may be encrypted using an authenticated encryption with associated data (AEAD) algorithm. In such embodiments, the associated data (AD) or AAD used for the AEAD can include one or more of the AAD parameters described herein.

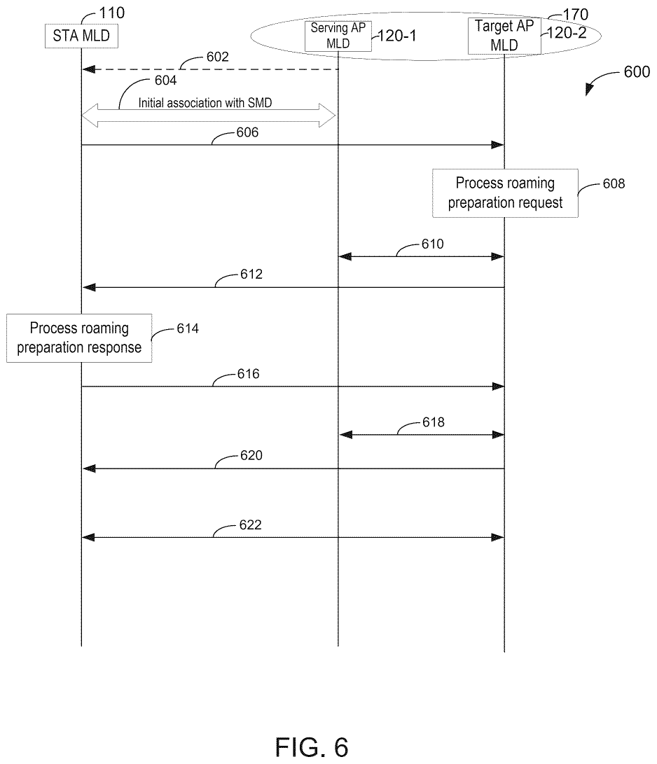

FIG. 6 illustrates an example call flow diagram 600 for enabling seamless roaming of a STA MLD 110 through a target AP MLD (e.g., AP MLD 120-2) within an SMD 170 without prior roaming preparation, using a shared PTK that is common across the AP MLDs 120 in the SMD 170.

At 602, one or more AP MLDs of the SMD 170, including the serving AP MLD (e.g., AP MLD 120-1), advertise SMD-related capability information. In the illustrated example, the advertised information may indicate that the network supports seamless roaming using a shared PTK across the SMD 170. Such advertisements may be included in beacon frames, probe response frames, (re)association response frames, or other management frames transmitted by the AP MLDs, and may enable the STA MLD 110 to determine that roaming to the target AP MLD can be performed without prior roaming preparation.

At 604, the STA MLD 110 performs an initial association with the SMD 170 via a serving AP MLD (e.g., AP MLD 120-1). Through this initial association, the STA MLD 110 may establish security context associated with the SMD 170, including cryptographic material usable for subsequent secure communications within the SMD 170. The cryptographic material may include a shared PTK and PMK. The shared PTK may be derived during authentication and key establishment procedures associated with the initial association and may be stored in association with an SMD identifier.

At 606, after selecting the target AP MLD for roaming, the STA MLD 110 transmits a roaming preparation request frame directly to the target AP MLD. In this embodiment, the roaming preparation request frame may be unencrypted. For example, the roaming preparation request frame may be transmitted without being fully protected by a PMF, since the target AP MLD has not yet established a security context for the STA MLD 110. In certain embodiments, the roaming preparation request frame may be partially encrypted using shared PTK or a signaling key that was established at the time of association. In certain embodiments, the STA MLD 110 may select the target AP MLD after determining that one or more criteria are satisfied, such as the STA MLD's received RSSI dropping below a predetermined threshold, as an illustrative example.

The roaming preparation request frame may include one or more client identifiers (e.g., a non-AP MLD MAC address, a one-time use identifier, a roaming MAC address, a PMKID), an identifier of the serving AP MLD, or any combination thereof. In certain embodiments, the roaming preparation request frame may further include a MIC generated by the STA MLD 110 using the shared PTK, thereby allowing the target AP MLD to verify that the STA MLD possesses the shared PTK associated with the SMD 170. For example, the roaming preparation request may trigger the target AP MLD to verify the client identifier and the SMD association of the client with the serving AP MLD. If there is a successful verification, then the shared PTK of the STA MLD 110 may be returned to the target AP MLD.

At 608, the target AP MLD processes the roaming preparation request frame. Processing the roaming preparation request frame may include identifying the STA MLD based on the included client identifier, validating replay protection rules, and/or verifying the MIC using the shared PTK. Successful verification confirms both the identity of the STA MLD 110 and the STA MLD's association with the SMD 170 via the shared PTK.

In certain embodiments, the target AP MLD may apply rate-limiting and/or policy-based filtering to roaming preparation requests to mitigate DoS attacks. For example, the replay validation at the target AP MLD may be performed based on the client identifier being designated for one-time use (e.g., one-time MAC address or a one-time token). If the request with a same client identifier is replayed, then the request may be discarded.

At 610, after successful processing of the roaming preparation request frame, the target AP MLD may fetch a client context associated with the STA MLD 110 from the serving AP MLD. The fetched context may include a security context, link configuration information, session parameters, and other state information that can be used to support roaming of the STA MLD 110 to the target AP MLD. In one embodiment, the target AP MLD may perform fetching of the context from the serving AP MLD as part of processing the roaming preparation request, since it may need to verify the client identifier and the SMD association of the client with the serving AP MLD, Thus, in some embodiments, steps 608 and 610 may be combined.

At 612, the target AP MLD transmits a roaming preparation response frame to the STA MLD 110. The roaming preparation response frame may include another MIC generated by the target AP MLD using the shared PTK, thereby enabling the STA MLD 110 to verify that the target AP MLD also possesses the shared PTK associated with the SMD 170.

In certain embodiments, the roaming preparation response frame is unencrypted. In some such embodiments, the roaming preparation response frame may include the client identifier, identifier of the serving AP MLD, the MIC generated by the target AP MLD, among other parameters. In certain embodiments, the roaming preparation response may be partially encrypted using shared PTK or a signaling key that was established at the time of association.

At 614, the STA MLD 110 processes the roaming preparation response frame received from the target AP MLD. Processing the roaming preparation response frame may include verifying the MIC in the roaming preparation response frame using the shared PTK (e.g., to verify that the target AP MLD also possesses the shared PTK) and/or confirming that the target AP MLD is authorized within the SMD 170 and capable of supporting roaming without prior preparation.

If the MIC verification is successful, then at 616, the STA MLD 110 transmits a roaming request frame to the target AP MLD. The roaming request frame may be a PMF protected frame and may request execution of roaming, including link setup on the target AP MLD and transfer of remaining context from the serving AP MLD. In certain embodiments, the roaming request frame may be implemented with (or similar to) a link reconfiguration request frame.

At 618, the target AP MLD performs roaming execution processing, including fetching any remaining context to be used to serve the STA MLD 110 and initiating updates within the distribution system (e.g., DS 140) for the STA MLD 110. The roaming context fetched at this stage may include one or more of a sequence number (SN) state, packet number (PN) state, block acknowledgment (BA) context, and near static context associated with the STA MLD 110. The near static context may include parameters that change infrequently and are maintained by the serving AP MLD, such as negotiated capabilities, traffic identifiers, or other session-related state information. In certain embodiments, the roaming context fetch may be coordinated via the distribution system. As part of this step, the target AP MLD may initiate a DS mapping update to redirect downlink traffic for the STA MLD 110 from the serving AP MLD to the target AP MLD, thereby enabling continuity of data traffic following the roaming operation.

At 620, the target AP MLD generates and transmits a roaming response frame to the STA MLD 110. The roaming response frame may indicate successful or unsuccessful roaming and may include information related to accepted links, security parameters (e.g., one or more group keys), association identifier (AID), and link configuration for the STA MLD on the target AP MLD. Portions of the roaming response frame may be protected using the shared PTK or PMF mechanisms. In certain embodiments, the roaming response frame may be implemented with (or similar to) a link reconfiguration response frame.

At 622, upon successful completion of the roaming procedure, data traffic (e.g., DL/UL data frames) may be exchanged between the STA MLD 110 and the target AP MLD. The data traffic may be protected using the shared PTK.

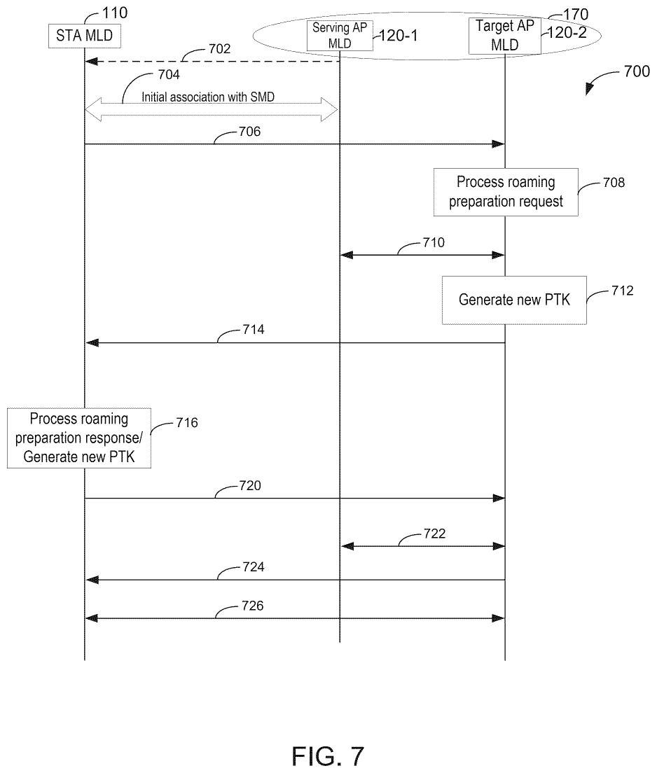

FIG. 7 illustrates an example call flow diagram 700 for enabling seamless roaming of a STA MLD 110 through a target AP MLD (e.g., AP MLD 120-2) within an SMD 170 without prior roaming preparation, according to certain embodiments. Here, a new PTK is generated for the target AP MLD since no prior roaming preparation has been performed with the target AP MLD.

At 702, one or more AP MLDs of the SMD 170, including the serving AP MLD (e.g., AP MLD 120-1), advertise SMD-related capability information. In the illustrated example, the advertised information may indicate that the network supports different PTKs for different AP MLDs 120 within the SMD 170. Such advertisements may be included in beacon frames, probe response frames, (re)association response frames, or other management frames transmitted by the AP MLDs, and may enable the STA MLD 110 to determine that roaming to the target AP MLD will involve generation of a new PTK.

At 704, the STA MLD 110 performs an initial association with the SMD 170 via a serving AP MLD (e.g., AP MLD 120-1). Through this initial association, the STA MLD 110 may establish security context associated with the SMD 170, including cryptographic material usable for subsequent secure communications within the SMD 170. The cryptographic material may include a PMK and an initial PTK associated with the serving AP MLD.

At 706, after selecting the target AP MLD for roaming, the STA MLD 110 transmits a roaming preparation request frame directly to the target AP MLD. In this embodiment, the roaming preparation request frame may be unencrypted. In certain embodiments, the roaming preparation request frame may be partially encrypted using a signaling key that was established at the time of association. In certain embodiments, the STA MLD 110 may select the target AP MLD after determining that one or more criteria are satisfied, such as the STA MLD's RSSI dropping below a predetermined threshold, as an illustrative example.

The roaming preparation request frame may include one or more client identifiers (e.g., a PMKID, a non-AP MLD MAC address, a one-time use identifier, etc.), an identifier of the serving AP MLD, a SNonce, a Diffie-Hellman ephemeral public key (EPK) (S_EPK) generated by the STA MLD 110, and other parameters used to initiate establishment of a new PTK with the target AP MLD. The roaming preparation request frame may trigger the target AP MLD to verify the client identifier (and SMD association of the STA MLD 110) with the serving AP MLD. Once the client identifier is verified at the serving AP MLD, the serving AP MLD may return the PMKSA to the target AP MLD. In certain embodiments, the roaming preparation request frame may be an enhanced version of a link reconfiguration request frame.

At 708, the target AP MLD processes the roaming preparation request frame. This processing may include verifying the identity of the STA MLD 110 and the STA MLD's association with the SMD 170, for example, by consulting the serving AP MLD. The processing may also include performing replay validation based on the client identifier (e.g., one-time identifiers or tokens) and generating a MIC for use in the roaming preparation response. Additionally, In certain embodiments, the target AP MLD may apply rate-limiting and/or policy-based filtering to roaming preparation requests to mitigate DoS attacks.

At 710, the target AP MLD fetches context associated with the STA MLD from the serving AP MLD. The fetched context may include security context and/or roaming related context.

At 712, the target AP MLD generates a new PTK for the STA. The new PTK may be derived using the common PMK, the SNonce and/or S_EPK received from the STA MLD 110, and the ANonce and/or a Diffie-Hellman ephemeral public key (A_EPK) generated by the target AP MLD.

At 714, the target AP MLD generates and transmits a roaming preparation response frame to the STA MLD. The roaming preparation response frame may be unencrypted and may include the client identifier, the identifier of the serving AP MLD, the ANonce and/or A_EPK generated by the target AP MLD, and the MIC generated by the target AP MLD using the newly generated PTK. In certain embodiments, the roaming preparation response frame may be partially encrypted using a signaling key that was established at the time of association. In certain embodiments, the roaming preparation response frame may be an enhanced version of a link reconfiguration response frame.

At 716, the STA MLD 110 processes the roaming preparation response frame. This processing may include generating the new PTK using the received ANonce and/or A_EPK, the previously generated SNonce and/or S_EPK, and the common PMK. The processing may also include verifying the MIC included in the roaming preparation response to confirm possession of the same new PTK as the target AP MLD. Following successful MIC verification, the STA MLD 110 can confirm that both the STA MLD 110 and the target AP MLD possess the same new PTK.

At 720, the STA MLD 110 transmits a roaming request frame to the target AP MLD. The roaming request frame may be PMF protected using the new PTK and may include identifiers of one or more links of the target AP MLD to be used for communication and/or the identifier of the serving AP MLD. In certain embodiments, the roaming request frame may be an enhanced version of a link reconfiguration request frame.

At 722, the target AP MLD fetches roaming context associated with the STA MLD 110. The roaming context may include one or more of a SN, PN, BA context, and/or near-static context. In certain embodiments, the target AP MLD may also initiate a distribution system mapping update to associate the STA MLD with the target AP MLD for subsequent data forwarding.

At 724, the target AP MLD generates and transmits a roaming response frame to the STA MLD 110. The roaming response frame may be PMF protected using the new PTK and may include a status indicating whether roaming is successful, identifiers of accepted links, group keys associated with the target AP MLD, an AID assigned to the STA MLD 110, and other parameters used to complete link setup and context transfer. In certain embodiments, the roaming response frame may be an enhanced version of a link reconfiguration response frame.

At 726, upon successful completion of the roaming procedure, data traffic (e.g., DL/UL data frames) may be exchanged between the STA MLD 110 and the target AP MLD. The data traffic may be protected using the new PTK.

### Example Operations

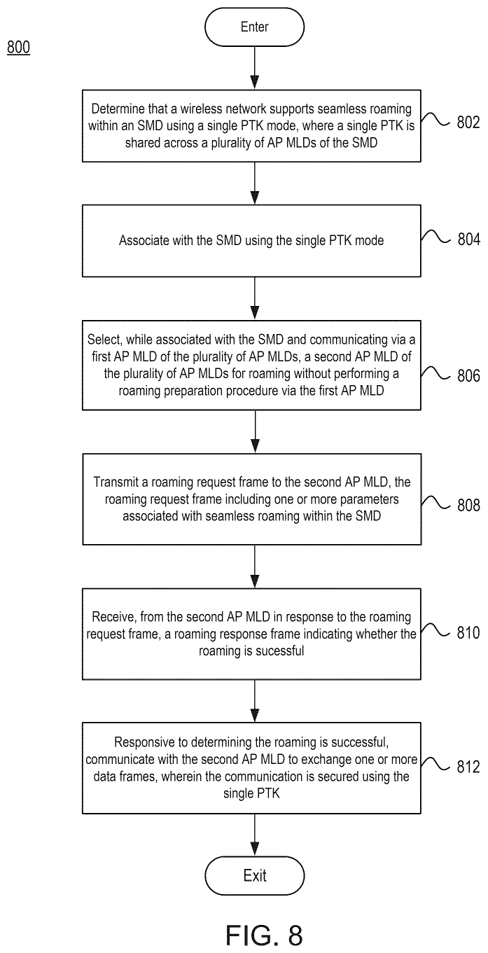

FIG. 8 is a flowchart of a method 800 for wireless communications. The method 1000 may be performed by a client device (e.g., STA MLD 110).

Method 800 enters at block 802, where the client device determines that a wireless network supports seamless roaming within an SMD (e.g., SMD 170) using a single PTK mode where a single PTK is shared across a plurality of AP MLDs (e.g., AP MLDs 120) of the SMD.

At block 804, the client device associates with the SMD using the single PTK mode.

At block 806, the client device selects, while associated with the SMD and communicating via a serving AP MLD (e.g., AP MLD 120-1) of the plurality of AP MLDs, a target AP MLD (e.g., AP MLD 120-2) of the plurality of AP MLDs for roaming without performing a roaming preparation procedure via the serving AP MLD.

At block 808, the client device transmits a roaming request frame to the target AP MLD. The roaming request frame includes one or more parameters associated with seamless roaming within the SMD.

At block 810, the client device receives, from the target AP MLD in response to the roaming request frame, a roaming response frame indicating whether the roaming is successful.

At block 812, the client device, responsive to determining the roaming is successful, communicates with the target AP MLD to exchange one or more data frames. The communication is secured using the single PTK.

In certain embodiments, the roaming request frame is a PMF.

In some such embodiments, the roaming request frame includes a transmitter address that identifies the client device, and this transmitter address appears in the frame header.

In some such embodiments, at least part of the roaming request frame is encrypted using the single PTK.

In some such embodiments, the roaming response frame is also a PMF.

In some such embodiments, the roaming request frame is transmitted without exchanging roaming preparation signaling with the target AP MLD through the serving AP MLD.

In some such embodiments, before transmitting the roaming request frame, the client device transmits a roaming preparation request frame to the target AP MLD.

In some such embodiments, the roaming preparation request frame is unencrypted.

In some such embodiments, the roaming preparation request frame includes a client identifier and an identifier of the serving AP MLD.

In some such embodiments, the roaming preparation request frame includes a MIC generated using the single PTK.

In some such embodiments, the client device receives a roaming preparation response frame from the target AP MLD in response.

In some such embodiments, the roaming preparation response frame includes a MIC generated using the single PTK.

In some such embodiments, the roaming request frame is transmitted after successful verification of that MIC in the roaming preparation response frame.

In certain embodiments, the roaming request frame includes an unencrypted portion and/or an encrypted portion, and one or more of the roaming parameters appear in the unencrypted portion.

In some such embodiments, the unencrypted portion contains an RSNE or a ML element.

In some such embodiments, the roaming parameters include a client identifier.

In some such embodiments, the client identifier includes a PMKID, a non-AP-MLD IRM, a roaming non-AP-MLD MAC address, or any combination of these.

In some such embodiments, the client identifier is intended for one-time use.

In some such embodiments, the roaming response frame contains updated client identifiers usable for subsequent roaming.

In some such embodiments, the encrypted portion of the roaming request frame is encrypted using either the single PTK or a signaling key established during initial SMD association.

In some such embodiments, the client device selects whether to use the single PTK or the signaling key for encryption based on a capability advertised by the target AP MLD.

In some such embodiments, the roaming request frame includes a MIC generated using either the single PTK or a signaling key.

In some such embodiments, that MIC in the roaming request frame is calculated over at least part of the encrypted portion or part of the unencrypted portion of the roaming-request frame.

In some such embodiments, the unencrypted portion includes AAD.

In some such embodiments, the roaming request frame is transmitted without exchanging roaming preparation signaling with the target AP MLD through the serving AP MLD.

In some such embodiments, the roaming parameters include a client identifier, an identifier of the serving AP MLD, or a MIC generated using the single PTK.

In some such embodiments, the encrypted portion includes a request to establish at least one link to the target AP MLD and a request to transfer a security context.

In some such embodiments, the roaming request frame includes a packet number used for encryption of the encrypted portion.

In some such embodiments, the roaming response frame includes an encrypted portion encrypted using the single PTK, a MIC generated using the single PTK, and a packet number associated with the encryption of the encrypted portion.

In some such embodiments, the client device verifies that MIC in the roaming response frame and, upon successful verification, determines the status of the requested link setup and context transfer.

In certain embodiments, the client device transmits a roaming confirmation frame to the target AP MLD to indicate that roaming is successful.

In some such embodiments, the roaming confirmation frame is a PMF.

In some such embodiments, the roaming confirmation frame is partially encrypted using the single PTK or a signaling key established during initial SMD association.

In certain embodiments, the roaming response frame includes a MIC generated using the single PTK or a signaling key established during initial SMD association.

In some such embodiments, that MIC in the roaming response frame is calculated over part of the encrypted portion or part of the unencrypted portion of the roaming response frame.

In some such embodiments, the unencrypted portion of the roaming response frame includes AAD.

In some such embodiments, the encrypted portion of the roaming response frame includes updated client identifiers for future roaming.

In some such embodiments, determining that roaming is successful includes verifying the MIC in the roaming response frame.

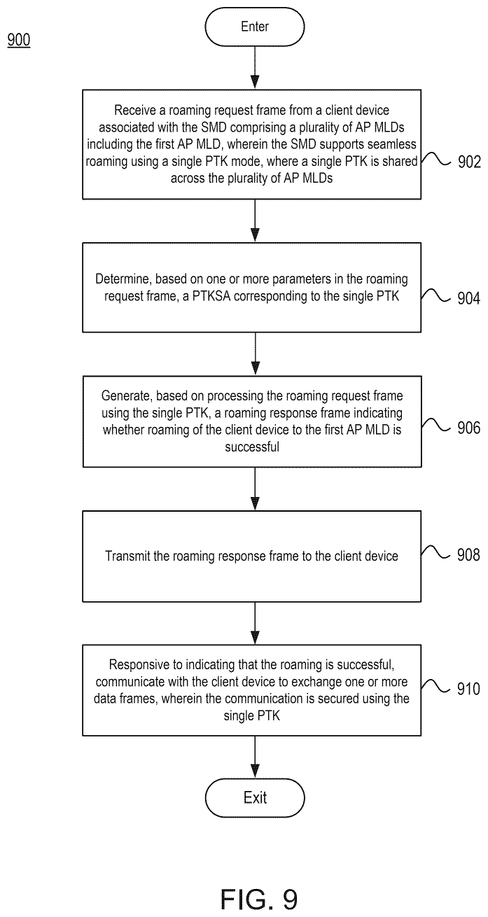

FIG. 9 is a flowchart of a method 900 for wireless communications. The method 900 may be performed by a target AP MLD (e.g., AP MLD 120-2).

At block 902, the target AP MLD receives a roaming request frame from a client device associated with the SMD comprising a plurality of AP MLDs including the target AP MLD. The SMD supports seamless roaming using a single PTK mode where a single PTK is shared across the plurality of AP MLDs. The client device is associated with the SMD using the single PTK mode.

At block 904, the target AP MLD determines, based on one or more parameters in the roaming request frame, a PTKSA corresponding to the single PTK.

At block 906, the target AP MLD generates, based on processing the roaming request frame using the single PTK, a roaming response frame indicating whether roaming of the client device to the target AP MLD is successful.

At block 908, the target AP MLD transmits the roaming response frame to the client device.

At block 910, the target AP MLD, responsive to indicating that roaming is successful, communicates with the client device to exchange one or more data frames, wherein the communication is secured using the single PTK.

In certain embodiments, the roaming request frame is a PMF.

In some such embodiments, the roaming request frame includes a transmitter address in its header.

In some such embodiments, determining the PTKSA includes mapping the transmitter address to the PTKSA for the client device within the SMD.

In some such embodiments, processing the roaming request frame includes decrypting at least part of the roaming request frame using the single PTK.

In some such embodiments, the roaming request frame is received without the client device having sent any roaming preparation signaling through another AP MLD via which the client device is communicating.

In some such embodiments, before receiving the roaming request frame, the target AP MLD receives a roaming preparation request frame from the client device.

In some such embodiments, the roaming preparation request frame is unencrypted.

In some such embodiments, the roaming preparation request frame includes a client identifier and an identifier of the serving AP MLD.

In some such embodiments, the roaming preparation request frame includes a MIC generated using the single PTK.

In some such embodiments, the target AP MLD verifies the MIC in the roaming preparation request frame using the PTKSA corresponding to the single PTK.

In some such embodiments, the target AP MLD transmits a roaming preparation response frame to the client device in response to the roaming preparation request frame.

In some such embodiments, the roaming preparation response frame includes a MIC generated using the single PTK.

In some such embodiments, the roaming preparation response frame is transmitted after successful verification of the MIC included in the roaming preparation request frame.

In certain embodiments, the target AP MLD obtains the single PTK from a controller, a key store, or another AP MLD before processing the roaming request frame.

In some such embodiments, the single PTK is obtained on demand in response to receiving the roaming request frame.

In certain embodiments, the roaming request frame is processed using the single PTK before that PTK is installed in hardware of the target AP MLD.

In some such embodiments, the single PTK is installed in hardware of the target AP MLD after determining that roaming is successful.

In certain embodiments, the roaming request frame includes an unencrypted portion and/or an encrypted portion.

In some such embodiments, the unencrypted portion includes an RSNE or a ML element.

In some such embodiments, the unencrypted portion includes a client identifier associated with the client device.

In some such embodiments, the client identifier includes a PMKID, a non-AP MLD IRM, a roaming non-AP MLD MAC address, or any combination thereof.

In some such embodiments, determining the PTKSA includes mapping the client identifier to the PTKSA for the client device within the SMD.

In some such embodiments, the encrypted portion of the roaming request frame is encrypted using the single PTK.

In some such embodiments, decrypting the encrypted portion is performed in software using the single PTK.

In some such embodiments, the encrypted portion is instead encrypted using a signaling key established during initial SMD association.

In some such embodiments, decrypting the encrypted portion is performed using the signaling key.

In certain embodiments, the roaming request frame includes a MIC.

In some such embodiments, this MIC in the roaming request frame is verified using either the single PTK or a signaling key established during initial SMD association.

In some such embodiments, the MIC in the roaming request frame is generated over at least part of an encrypted portion or at least part of an unencrypted portion of the roaming request frame.

In certain embodiments, the roaming response frame is a PMF.

In certain embodiments, the roaming response frame includes an encrypted portion and/or an unencrypted portion.

In some such embodiments, the unencrypted portion includes AAD.

In certain embodiments, the roaming response frame includes a MIC generated using either the single PTK or a signaling key established during initial SMD association.

In certain embodiments, the roaming response frame includes updated client identifiers for subsequent roaming operations.

In certain embodiments, the target AP MLD receives a roaming confirmation frame from the client device.

In some such embodiments, the roaming confirmation frame is a PMF.

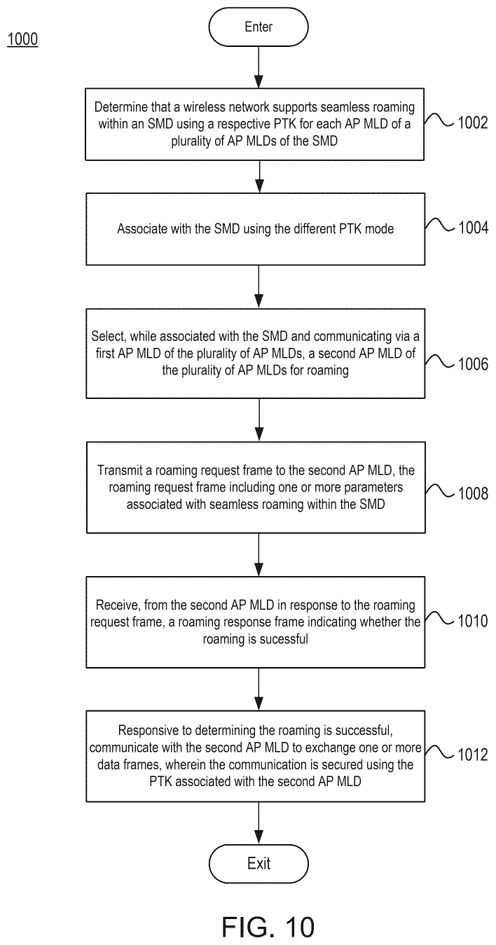

FIG. 10 is a flowchart of a method 1000 for wireless communications. The method 1200 may be performed by a client device (e.g., STA MLD 110).

At block 1002, the client device determines that a wireless network supports seamless roaming within an SMD using a different PTK mode where a separate PTK is generated for each AP MLD of a plurality of AP MLDs of the SMD.

At block 1004, the client device associates with the SMD using the different PTK mode.

At block 1006, the client device selects, while associated with the SMD and communicating via a serving AP MLD of the plurality of AP MLDs, a target AP MLD of the plurality of AP MLDs for roaming.

At block 1008, the client device transmits a roaming request frame to the target AP MLD, the roaming request frame comprising one or more parameters associated with seamless roaming within the SMD.

At block 1010, the client device receives, from the target AP MLD in response to the roaming request frame, a roaming response frame indicating whether the roaming is successful.

At block 1012, the client device, responsive to determining the roaming is successful, communicates with the target AP MLD to exchange one or more data frames, wherein the communication is secured using the PTK associated with the target AP MLD.

In certain embodiments, the client device establishes the PTK associated with the target AP MLD before transmitting the roaming request frame.

In some such embodiments, establishing the PTK includes performing a roaming preparation procedure with the target AP MLD via the serving AP MLD.

In some such embodiments, the roaming request frame is a PMF secured using the PTK associated with the target AP MLD.

In some such embodiments, the roaming request frame includes a transmitter address identifying the client device, and this address appears in the frame header.

In some such embodiments, the roaming response frame is a PMF secured using the PTK associated with the target AP MLD.

In some such embodiments, the roaming request frame includes an unencrypted portion and/or an encrypted portion, with the roaming parameters included in the unencrypted portion.

In some such embodiments, the unencrypted portion includes an RSNE or a ML element.

In some such embodiments, the roaming parameters include a client identifier.

In some such embodiments, the client identifier includes a PMKID, a non-AP MLD IRM, a roaming non-AP MLD MAC address, or a combination thereof.

In some such embodiments, the client identifier is intended for one-time use.

In some such embodiments, the encrypted portion of the roaming request frame is protected using either a signaling key established before roaming or the PTK associated with the target AP MLD.

In some such embodiments, the roaming response frame includes an encrypted portion and/or an unencrypted portion.

In some such embodiments, the encrypted portion of the roaming response frame is encrypted using the PTK associated with the target AP MLD or a signaling key established prior to roaming.

In some such embodiments, the encrypted portion of the roaming response frame includes updated client identifiers usable for future roaming operations.

In some such embodiments, the roaming request frame includes a first MIC generated using the PTK associated with the target AP MLD.

In some such embodiments, the roaming response frame includes a second MIC generated using the PTK associated with the target AP MLD.

In some such embodiments, the client device verifies the second MIC in the roaming response frame and, upon successful verification, determines that roaming is successful.

In certain embodiments, the roaming request frame is transmitted without previously establishing the PTK associated with the target AP MLD.

In some such embodiments, the roaming request frame includes at least one of a nonce, an ephemeral public key, or key derivation parameters.

In some such embodiments, the client device generates the PTK associated with the target AP MLD based on parameters included in the roaming response frame.

In some such embodiments, the parameters included in the roaming response frame include at least one of a nonce, an ephemeral public key, or key-derivation parameters.

In some such embodiments, the client device exchanges data frames with the target AP MLD after generating the PTK associated with the target AP MLD.

In some such embodiments, before transmitting the roaming request frame, the client device transmits a roaming preparation request frame to the target AP MLD.

In some such embodiments, the roaming preparation request frame is unencrypted.

In some such embodiments, the roaming preparation request frame includes a client identifier and an identifier of the serving AP MLD.

In some such embodiments, the roaming preparation request frame includes at least one of a client nonce or an ephemeral public key.

In some such embodiments, the client device receives a roaming preparation response frame from the target AP MLD.

In some such embodiments, the roaming preparation response frame is unencrypted and includes at least one of a client identifier, a nonce, or a MIC.

In certain embodiments, the client device transmits a roaming confirmation frame to the target AP MLD in response to the roaming-response frame.

In some such embodiments, the roaming confirmation frame is protected using the PTK associated with the target AP MLD.

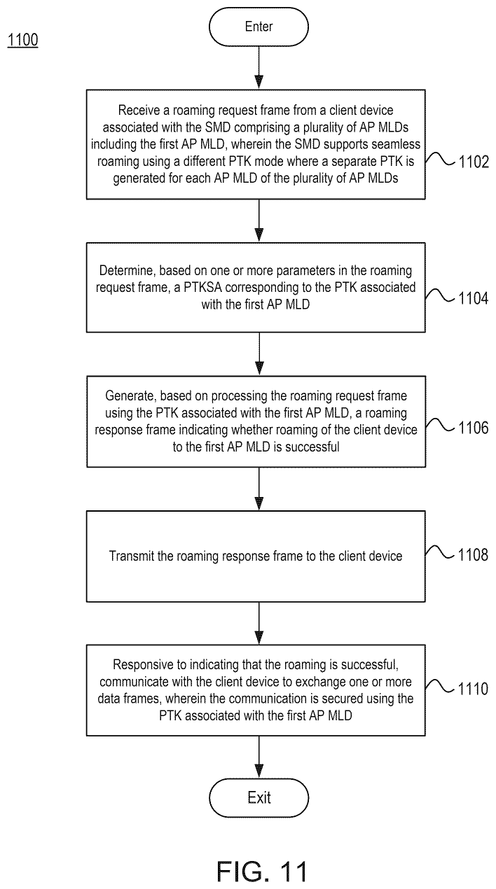

FIG. 11 is a flowchart of a method 1100 for wireless communications. The method 1100 may be performed by a target AP MLD (e.g., AP MLD 120-2).

At block 1102, the target AP MLD receives a roaming request frame from a client device associated with the SMD comprising a plurality of AP MLDs including the target AP MLD. The SMD supports seamless roaming using a different PTK mode where a separate PTK is generated for each AP MLD of the plurality of AP MLDs. The client device is associated with the SMD using the different PTK mode.

At block 1104, the target AP MLD determines, based on one or more parameters in the roaming request frame, a PTKSA corresponding to the PTK associated with the target AP MLD.

At block 1106, the target AP MLD generates, based on processing the roaming request frame using the PTK associated with the target AP MLD, a roaming response frame indicating whether roaming of the client device to the target AP MLD is successful.

At block 1108, the target AP MLD transmits the roaming response frame to the client device.

At block 1110, the target AP MLD, responsive to indicating that roaming is successful, communicates with the client device to exchange one or more data frames. The communication is secured using the PTK associated with the target AP MLD.

In certain embodiments, the target AP MLD establishes the PTK associated with the target AP MLD before receiving the roaming request frame.

In some such embodiments, establishing the PTK includes performing a roaming preparation procedure with the client device via a serving AP MLD through which the client device is communicating.

In some such embodiments, the roaming request frame is a PMF secured using the PTK associated with the target AP MLD.

In some such embodiments, the roaming request frame includes a transmitter address identifying the client device, and this address appears in the frame header.

In some such embodiments, determining the PTKSA includes mapping the transmitter address to the PTKSA corresponding to the PTK associated with the target AP MLD.

In some such embodiments, processing the roaming request frame includes decrypting at least part of the roaming request frame using the PTK associated with the target AP MLD.

In some such embodiments, the roaming response frame is a PMF secured using the PTK associated with the target AP MLD.

In some such embodiments, the roaming request frame includes an unencrypted portion and/or an encrypted portion, with the roaming related parameters included in the unencrypted portion.

In some such embodiments, the unencrypted portion includes an RSNE or a ML element.

In some such embodiments, the roaming related parameters include a client identifier.

In some such embodiments, the client identifier includes a PMKID, a non-AP MLD identifiable random MAC address, a roaming non-AP MLD MAC address, or a combination thereof.

In some such embodiments, the client identifier is intended for one-time use.

In some such embodiments, determining the PTKSA includes mapping the client identifier to the PTKSA corresponding to the PTK associated with the target AP MLD.

In some such embodiments, processing the roaming request frame includes decrypting at least a portion of the encrypted portion using either a signaling key established before roaming or the PTK associated with the target AP MLD.

In some such embodiments, the roaming response frame includes an encrypted portion and/or an unencrypted portion.

In some such embodiments, the encrypted portion of the roaming response frame is encrypted using the PTK associated with the target AP MLD or a signaling key established prior to roaming.

In some such embodiments, the encrypted portion of the roaming response frame includes updated client identifiers available for future roaming operations.

In certain embodiments, the roaming request frame is received even though the PTK associated with the target AP MLD has not previously been established for the client device.

In some such embodiments, the target AP MLD generates the PTK associated with the target AP MLD based on parameters included in the roaming request frame.

In some such embodiments, the parameters include at least one of a nonce, an ephemeral public key, or key derivation parameters.

In some such embodiments, the roaming response frame includes parameters that allow the client device to generate the PTK associated with the target AP MLD.

In some such embodiments, communication with the client device using the PTK associated with the target AP MLD occurs only after that PTK is generated.

In certain embodiments, the target AP MLD receives a roaming preparation request frame from the client device before receiving the roaming request frame.

In some such embodiments, the roaming preparation request frame is unencrypted.

In some such embodiments, the roaming preparation request frame includes a client identifier or an identifier of a serving AP MLD through which the client device is communicating.

In some such embodiments, the target AP MLD transmits a roaming preparation response frame in response to the roaming preparation request frame.

In some such embodiments, the roaming preparation response frame includes information usable to generate the PTK associated with the target AP MLD.

In some such embodiments, the roaming request frame is processed after transmitting the roaming preparation response frame.

In certain embodiments, the roaming request frame includes a first MIC.

In some such embodiments, the first MIC is verified using either the PTK associated with the target AP MLD or a signaling key.

In some such embodiments, the roaming response frame includes a second MIC.

In certain embodiments, the roaming request frame is processed in software before the PTK associated with the target AP MLD is installed in hardware.

In some such embodiments, the PTK associated with the target AP MLD is installed in hardware after roaming is determined to be successful.

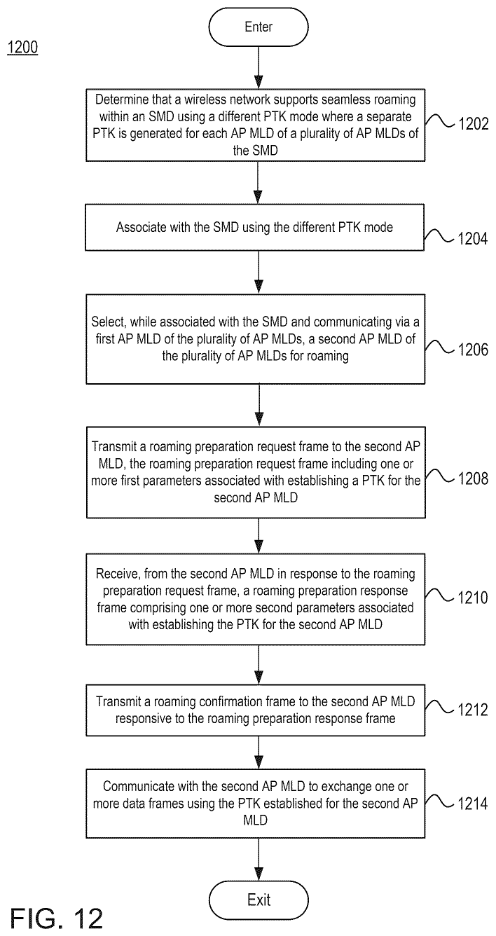

FIG. 12 is a flowchart of a method 1200 for wireless communications. The method 1200 may be performed by a client device (e.g., STA MLD 110).

At block 1202, the client device determines that a wireless device supports seamless roaming within an SMD using a different PTK mode where a separate PTK is generated for each AP MLD of a plurality of AP MLDs of the SMD.

At block 1204, the client device associates with the SMD using the different PTK mode.

At block 1206, the client device selects, while associated with the SMD and communicating via a serving AP MLD of the plurality of AP MLDs, a target AP MLD of the plurality of AP MLDs for roaming.

At block 1208, the client device transmits a roaming preparation request frame to the target AP MLD. The roaming preparation request frame includes one or more first parameters associated with establishing a PTK for the target AP MLD.

At block 1210, the client device receives, from the target AP MLD in response to the roaming preparation request frame, a roaming preparation response frame comprising one or more second parameters associated with establishing the PTK for the target AP MLD.

At block 1212, the client devices transmits a roaming confirmation frame to the second AP MLD responsive to the roaming preparation response frame.

At block 1214, the client device communicates with the target AP MLD to exchange one or more data frames using the PTK established for the target AP MLD.

In certain embodiments, roaming from the serving AP MLD to the target AP MLD is completed without transmitting a roaming request frame to the target AP MLD or receiving a roaming response frame from the target AP MLD.

In certain embodiments, the roaming preparation request frame is transmitted without previously establishing the PTK associated with the target AP MLD.

In certain embodiments, the roaming preparation request frame is unencrypted.

In certain embodiments, the first parameters included in the roaming preparation request frame include at least one of a client identifier, an identifier of the serving AP MLD, a client nonce, an ephemeral public key, information for link setup between the client device and the target AP MLD, or information for transferring the security context for the client device.

In some such embodiments, the client identifier is designated for one-time use.

In some such embodiments, the second parameters included in the roaming preparation response frame include at least one of a nonce generated by the target AP MLD, an ephemeral public key generated by the target AP MLD, one or more key derivation parameters, a MIC generated based on the PTK for the target AP MLD, or a status of link setup or security context transfer.

In some such embodiments, the MIC included in the roaming preparation response frame is verified.

In certain embodiments, the client device generates the PTK for the target AP MLD based at least in part on the second parameters.

In certain embodiments, the roaming confirmation frame is a PMF secured using the PTK established for the target AP MLD.

In some such embodiments, the roaming confirmation frame includes a MIC generated based in part on the PTK established for the target AP MLD.

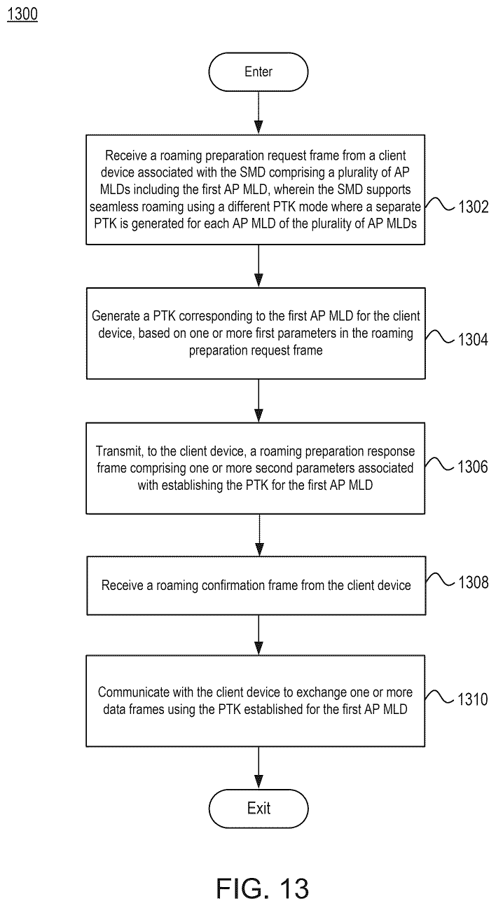

FIG. 13 is a flowchart of a method 1300 for wireless communications. The method 1300 may be performed by a target AP MLD (e.g., AP MLD 120-2).

At block 1302, the target AP MLD receives a roaming preparation request frame from a client device associated with the SMD comprising a plurality of AP MLDs including the target AP MLD. The SMD supports seamless roaming using a different PTK mode where a separate PTK is generated for each AP MLD of the plurality of AP MLDs. The client device is associated with the SMD using the different PTK mode.

At block 1304, the target AP MLD generates a PTK corresponding to the target AP MLD for the client device, based on one or more first parameters in the roaming preparation request frame.

At block 1306, the target AP MLD transmits, to the client device, a roaming preparation response frame comprising one or more second parameters associated with establishing the PTK for the target AP MLD.

At block 1308, the target AP MLD receives a roaming confirmation frame from the client device. The roaming confirmation frame may be a PMF protected using the PTK established by the client device for the target AP MLD.

At block 1310, the target AP MLD communicates with the client device to exchange one or more data frames using the PTK established for the target AP MLD.

In certain embodiments, the roaming preparation request frame is received without receiving a roaming request frame from the client device.

In certain embodiments, roaming of the client device to the target AP MLD is completed without generating a roaming response frame.

In certain embodiments, the roaming preparation request frame is unencrypted.

In certain embodiments, the roaming preparation request frame includes at least one of a client identifier or an identifier of a serving AP MLD through which the client device is communicating.

In some such embodiments, the client identifier is designated for one-time use.

In certain embodiments, the first parameters included in the roaming preparation request frame include at least one of a client identifier, an identifier of the target AP MLD, a client nonce, an ephemeral public key, information for link setup with the target AP MLD, or information for transferring a security context for the client device.

In some such embodiments, the second parameters included in the roaming preparation response frame include at least one of a nonce generated by the target AP MLD, an ephemeral public key generated by the target AP MLD, one or more key derivation parameters, a MIC generated based on the PTK for the target AP MLD, or a status of link setup or security context transfer.

In certain embodiments, the roaming preparation request frame includes a MIC.

In some such embodiments, the MIC is verified using a key derived from a PMK associated with the SMD.

In some such embodiments, the MIC is generated over at least part of the roaming preparation request frame and additional authentication data.

In some such embodiments, the roaming preparation response frame is generated in response to successfully verifying the MIC included in the roaming preparation request frame.

In certain embodiments, the PTK for the target AP MLD is established before any data frames are exchanged with the client device.

In certain embodiments, the roaming preparation response frame includes updated client identifiers for use during subsequent roaming operations.

In certain embodiments, the PTK for the target AP MLD is generated in software before being installed in hardware.

In some such embodiments, the PTK is installed in hardware of the target AP MLD after the roaming preparation response frame is transmitted.

### Example Computing Device

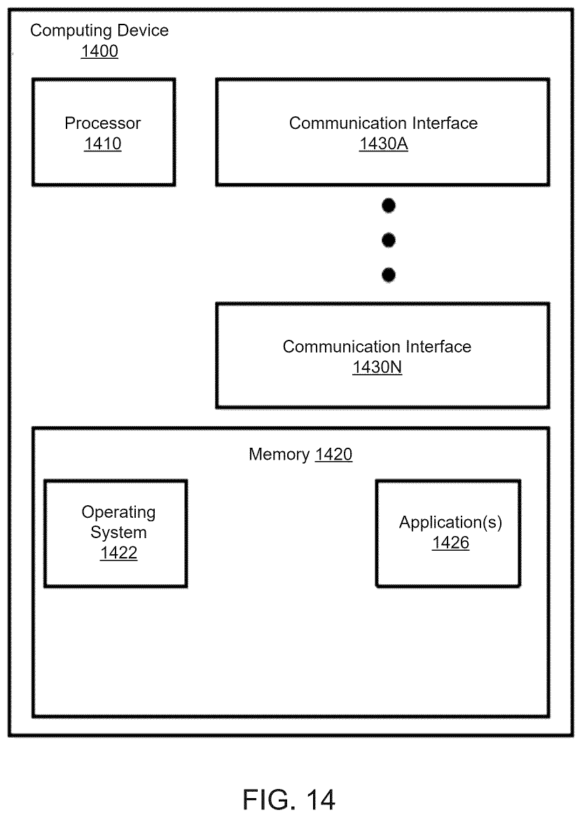

FIG. 14 illustrates an example computing device 1400, according to one embodiment. The computing device 1400 can be configured to perform one or more techniques described herein. For example, the computing device 1400 can perform method 800, method 900, method 1000, method 1100, method 1200, method 1300, and any other techniques (or combination of techniques) described herein. The computing device 1400 may be representative of a controller (e.g., controller 130), a network entity (e.g., an AP MLD, such as AP MLD 120), or a wireless device (e.g., STA MLD 110). The computing device 1400 includes, without limitation, a processor 1410, a memory 1420, and one or more communication interfaces 1430a-n (generally, communication interface 1430). In one example, the communication interface 1430 includes a radio.

The processor 1410 may be any processing element capable of performing the functions described herein. The processor 1410 represents a single processor, multiple processors, a processor with multiple cores, and combinations thereof. The communication interfaces 1430 (e.g., radios) facilitate communications between the computing device 1400 and other devices. The communications interfaces 1430 are representative of wireless communications antennas and various wired communication ports.

The memory 1420 may be either volatile or non-volatile memory and may include RAM, flash, cache, disk drives, and other computer readable memory storage devices. Although shown as a single entity, the memory 1420 may be divided into different memory storage elements such as RAM and one or more hard disk drives. As shown, the memory 1420 includes various instructions that are executable by the processor 1410 to provide an operating system 1422 to manage various functions of the computing device 1400. The memory 1420 also includes one or more application(s) 1426.

The computing device 1400 may include storage (not shown). In some cases, the storage may be a disk drive or flash storage device. In some cases, the storage may be a combination of fixed and/or removable storage devices, such as fixed disc drives, solid state drives, removable memory cards, optical storage, network attached storage (NAS), or a storage area-network (SAN).

### Example Clauses

Implementation examples are described in the following numbered clauses:

Clause 1: A computer-implemented method for wireless communications performed by a client device, comprising: determining that a wireless network supports seamless roaming within a seamless mobility domain (SMD) using a single pairwise transient key (PTK) mode where a single PTK is shared across a plurality of access point (AP) multi-link devices (MLDs) of the SMD; associating with the SMD using the single PTK mode; selecting, while associated with the SMD and communicating via a first AP MLD of the plurality of AP MLDs, a second AP MLD of the plurality of AP MLDs for roaming without performing a roaming preparation procedure via the first AP MLD; transmitting a roaming request frame to the second AP MLD, the roaming request frame comprising one or more parameters associated with seamless roaming within the SMD; receiving, from the second AP MLD in response to the roaming request frame, a roaming response frame indicating whether the roaming is successful; and responsive to determining the roaming is successful, communicating with the second AP MLD to exchange one or more data frames, wherein the communication is secured using the single PTK.

Clause 2: The computer-implemented method of claim 1, wherein the roaming request frame is a protected management frame (PMF) protected using the single PTK.

Clause 3: The computer-implemented method of Clause 2, wherein: the one or more parameters comprise a transmitter address that identifies the client device; and the transmitter address is included in a header of the roaming request frame.

Clause 4: The computer-implemented method of Clause 2, wherein at least a portion of the roaming request frame is encrypted using the single PTK.

Clause 5: The computer-implemented method of Clause 2, wherein the roaming response frame is a PMF.

Clause 6: The computer-implemented method of Clause 2, wherein the roaming request frame is transmitted without having exchanged roaming preparation signaling with the second AP MLD via the first AP MLD.

Clause 7: The computer-implemented method of Clause 6, further comprising, prior to transmitting the roaming request frame, transmitting a roaming preparation request frame to the second AP MLD.

Clause 8: The computer-implemented method of Clause 7, wherein the roaming preparation request frame is unencrypted.

Clause 9: The computer-implemented method of Clause 7, wherein the roaming preparation request frame comprises a client identifier and an identifier of the first AP MLD.

Clause 10: The computer-implemented method of Clause 7, wherein the roaming preparation request frame comprises a message integrity check (MIC) generated using the single PTK.

Clause 11: The computer-implemented method of Clause 7, further comprising receiving, from the second AP MLD, a roaming preparation response frame in response to the roaming preparation request frame.

Clause 12: The computer-implemented method of Clause 11, wherein the roaming preparation response frame comprises a message integrity check (MIC) generated using the single PTK.

Clause 13: The computer-implemented method of Clause 12, wherein the roaming request frame is transmitted based on a successful verification of the MIC in the roaming preparation response frame.

Clause 14: The computer-implemented method of Clause 1, wherein: the roaming request frame comprises at least one of an unencrypted portion or an encrypted portion; and the one or more parameters are included in the unencrypted portion.

Clause 15: The computer-implemented method of Clause 14, wherein the unencrypted portion comprises a robust security network element (RSNE) or a multi-link (ML) element.

Clause 16: The computer-implemented method of Clause 14, wherein the one or more parameters comprise a client identifier.

Clause 17: The computer-implemented method of Clause 16, wherein the client identifier comprises (i) a pairwise master key identifier (PMKID), (ii) a non-AP MLD identifiable random medium access control (MAC) address (IRM), (iii) a roaming non-AP MLD MAC address, or (iv) a combination thereof.

Clause 18: The computer-implemented method of Clause 16, wherein the client identifier is designated for one-time use.

Clause 19: The computer-implemented method of Clause 18, wherein the roaming response frame comprises one or more updated client identifiers available for use in a subsequent roaming operation.

Clause 20: The computer-implemented method of Clause 14, wherein the encrypted portion of the roaming request frame is encrypted using the single PTK or a signaling key established during an initial association with the SMD.

Clause 21: The computer-implemented method of Clause 20, further comprising determining to use the single PTK or the signaling key to encrypt the encrypted portion of the roaming request frame based on a capability advertised by the second AP MLD.

Clause 22: The computer-implemented method of Clause 14, wherein the roaming request frame further comprises a message integrity check (MIC) generated using the single PTK or a signaling key established during an initial association with the SMD.

Clause 23: The computer-implemented method of Clause 22, wherein the MIC is generated over at least one of (i) at least one portion of the encrypted portion of the roaming request frame or (ii) at least one portion of the unencrypted portion of the roaming request frame.

Clause 24: The computer-implemented method of Clause 22, wherein the unencrypted portion of the roaming request frame comprises additional authentication data (AAD).

Clause 25: The computer-implemented method of Clause 14, wherein the roaming request frame is transmitted without having exchanged roaming preparation signaling with the second AP MLD via the first AP MLD.

Clause 26: The computer-implemented method of Clause 25, wherein the one or more parameters comprise at least one of a client identifier, an identifier of the first AP MLD, or a message integrity check (MIC) generated using the single PTK over at least a portion of the roaming request frame.

Clause 27: The computer-implemented method of Clause 25, wherein the encrypted portion comprises (i) a request to setup at least one link between the client device and the second AP MLD and (ii) a request to transfer a security context for the client device.

Clause 28: The computer-implemented method of Clause 27, wherein the roaming request frame comprises a packet number (PN) associated with encryption of the encrypted portion.

Clause 29: The computer-implemented method of Clause 27, wherein the roaming response frame comprises (i) an encrypted portion encrypted using the single PTK, (ii) a message integrity check (MIC) generated using the single PTK over at least a portion of the roaming response frame, and (iii) a packet number (PN) associated with encryption of the encrypted portion of the roaming response frame.

Clause 30: The computer-implemented method of Clause 29, further comprising: verifying the MIC in the roaming response frame; and upon successful verification of the MIC in the roaming response frame, determining a status of the request to setup the at least one link between the client device and the second AP MLD and a status of the request to transfer the security context.

Clause 31: The computer-implemented method of Clause 1, further comprising transmitting a roaming confirmation frame to the second AP MLD indicating the roaming is successful.

Clause 32: The computer-implemented method of Clause 31, wherein the roaming confirmation frame is a protected management frame (PMF).

Clause 33: The computer-implemented method of Clause 31, wherein the roaming confirmation frame is partially encrypted using the single PTK or a signaling key established during an initial association with the SMD.

Clause 34: The computer-implemented method of Clause 1, wherein the roaming response frame comprises a message integrity check (MIC) generated using the single PTK or a signaling key established during an initial association with the SMD.

Clause 35: The computer-implemented method of Clause 34, wherein the MIC is generated over at least one of (i) at least one portion of an encrypted portion of the roaming response frame or (ii) at least one portion of an unencrypted portion of the roaming response frame.

Clause 36: The computer-implemented method of Clause 35, wherein the unencrypted portion of the roaming response frame comprises additional authentication data (AAD).

Clause 37: The computer-implemented method of Clause 35, wherein the encrypted portion of the roaming response frame comprises one or more updated client identifiers available for use in a subsequent roaming operation.

Clause 38: The computer-implemented method of Clause 34, wherein determining the roaming is successful comprises determining a successful verification of the MIC in the roaming response frame.

Clause 39: A computer-implemented method for wireless communications performed by a client device, comprising: determining that a wireless network supports seamless roaming within a seamless mobility domain (SMD) using a different pairwise transient key (PTK) mode where a separate PTK is generated for each access point (AP) multi-link device (MLD) of a plurality of AP MLDs of the SMD; associating with the SMD using the different PTK mode; selecting, while associated with the SMD and communicating via a first AP MLD of the plurality of AP MLDs, a second AP MLD of the plurality of AP MLDs for roaming; transmitting a roaming request frame to the second AP MLD, the roaming request frame comprising one or more parameters associated with seamless roaming within the SMD; receiving, from the second AP MLD in response to the roaming request frame, a roaming response frame indicating whether the roaming is successful; and responsive to determining the roaming is successful, communicating with the second AP MLD to exchange one or more data frames, wherein the communication is secured using the PTK associated with the second AP MLD.

Clause 40: The computer-implemented method of Clause 39, further comprising, prior to transmitting the roaming request frame, establishing the PTK associated with the second AP MLD.

Clause 41: The computer-implemented method of Clause 40, wherein establishing the PTK associated with the second AP MLD comprises performing a roaming preparation procedure with the second AP MLD via the first AP MLD.

Clause 42: The computer-implemented method of Clause 40, wherein the roaming request frame is a protected management frame (PMF) protected using the PTK associated with the second AP MLD.

Clause 43: The computer-implemented method of Clause 42, wherein: the one or more parameters comprise a transmitter address that identifies the client device; and the transmitter address is included in a header of the roaming request frame.

Clause 44: The computer-implemented method of Clause 42, wherein the roaming response frame is a PMF protected using the PTK associated with the second AP MLD.

Clause 45: The computer-implemented method of Clause 40, wherein: the roaming request frame comprises at least one of an unencrypted portion or an encrypted portion; and the one or more parameters are included in the unencrypted portion.

Clause 46: The computer-implemented method of Clause 45, wherein the unencrypted portion comprises a robust security network element (RSNE) or a multi-link (ML) element.

Clause 47: The computer-implemented method of Clause 45, wherein the one or more parameters comprise a client identifier.

Clause 48: The computer-implemented method of Clause 47, wherein the client identifier comprises (i) a pairwise master key identifier (PMKID), (ii) a non-AP MLD identifiable random medium access control (MAC) address (IRM), (iii) a roaming non-AP MLD MAC address, or (iv) a combination thereof.

Clause 49: The computer-implemented method of Clause 47, wherein the client identifier is designated for one-time use.

Clause 50: The computer-implemented method of Clause 47, wherein the encrypted portion of the roaming request frame is protected using a signaling key established prior to roaming or the PTK associated with the second AP MLD.

Clause 51: The computer-implemented method of Clause 50, wherein the roaming response frame comprises at least one of an encrypted portion or an unencrypted portion.

Clause 52: The computer-implemented method of Clause 51, wherein the encrypted portion of the roaming response frame is encrypted using the PTK associated with the second AP MLD or a signaling key established prior to roaming.

Clause 53: The computer-implemented method of Clause 50, wherein the encrypted portion of the roaming response frame comprises one or more updated client identifiers available for use in a subsequent roaming operation.

Clause 54: The computer-implemented method of Clause 45, wherein the roaming request frame further comprises a first message integrity check (MIC) generated using the PTK associated with the second AP MLD.

Clause 55: The computer-implemented method of Clause 54, wherein the roaming response frame further comprises a second MIC generated using the PTK associated with the second AP MLD.

Clause 56: The computer-implemented method of Clause 55, further comprising: verifying the second MIC in the roaming response frame; and upon successful verification of the second MIC, determining the roaming is successful.

Clause 57: The computer-implemented method of Clause 39, wherein the roaming request frame is transmitted without previously establishing the PTK associated with the second AP MLD.

Clause 58: The computer-implemented method of Clause 57, wherein the one or more parameters in the roaming request frame comprise at least one of a nonce, an ephemeral public key, or one or more key derivation parameters.

Clause 59: The computer-implemented method of Clause 57, further comprising generating the PTK associated with the second AP MLD based on one or more parameters included in the roaming response frame.

Clause 60: The computer-implemented method of Clause 59, wherein the one or more parameters included in the roaming response frame comprise at least one of a nonce, an ephemeral public key, or one or more key derivation parameters.

Clause 61: The computer-implemented method of Clause 59, wherein communicating with the second AP MLD to exchange the one or more data frames occurs after generating the PTK associated with the second AP MLD.

Clause 62: The computer-implemented method of Clause 57, further comprising, prior to transmitting the roaming request frame, transmitting a roaming preparation request frame to the second AP MLD.

Clause 63: The computer-implemented method of Clause 62, wherein the roaming preparation request frame is unencrypted.

Clause 64: The computer-implemented method of Clause 62, wherein the roaming preparation request frame comprises a client identifier and an identifier of the first AP MLD.

Clause 65: The computer-implemented method of Clause 62, wherein the roaming preparation request frame comprises at least one of a client nonce or an ephemeral public key.

Clause 66: The computer-implemented method of Clause 62, further comprising receiving, from the second AP MLD in response to the roaming preparation request frame, a roaming preparation response frame.

Clause 67: The computer-implemented method of Clause 66, wherein the roaming preparation response frame is unencrypted and comprises at least one of a client identifier, a nonce, or a message integrity check (MIC).

Clause 68: The computer-implemented method of Clause 39, further comprising transmitting a roaming confirmation frame to the second AP MLD responsive to the roaming response frame.

Clause 69: The computer-implemented method of Clause 68, wherein the roaming confirmation frame is protected using the PTK associated with the second AP MLD.

Clause 70: A computer-implemented method for wireless communications performed by a client device, comprising: determining that a wireless device supports seamless roaming within a seamless mobility domain (SMD) using a different pairwise transient key (PTK) mode where a separate PTK is generated for each access point (AP) multi-link device (MLD) of a plurality of AP MLDs of the SMD; associating with the SMD using the different PTK mode; selecting, while associated with the SMD and communicating via a first AP MLD of the plurality of AP MLDs, a second AP MLD of the plurality of AP MLDs for roaming; transmitting a roaming preparation request frame to the second AP MLD, the roaming preparation request frame comprising one or more first parameters associated with establishing a PTK for the second AP MLD; receiving, from the second AP MLD in response to the roaming preparation request frame, a roaming preparation response frame comprising one or more second parameters associated with establishing the PTK for the second AP MLD; and communicating with the second AP MLD to exchange one or more data frames using the PTK established for the second AP MLD.

Clause 71: The computer-implemented method of Clause 70, wherein roaming from the first AP MLD to the second AP MLD is completed without at least one of transmitting a roaming request frame to the second AP MLD or receiving a roaming response frame from the second AP MLD.

Clause 72: The computer-implemented method of Clause 70, wherein the roaming preparation request frame is transmitted without previously establishing the PTK associated with the second AP MLD.

Clause 73: The computer-implemented method of Clause 70, wherein the roaming preparation request frame is unencrypted.

Clause 74: The computer-implemented method of Clause 70, wherein the one or more first parameters comprise at least one of (i) a client identifier, (ii) an identifier of the first AP MLD, (iii) a client nonce, (iv) ephemeral public key, (v) first information associated with link setup between the client device and the second AP MLD, or (vi) second information associated with transfer of a security context for the client device.

Clause 75: The computer-implemented method of Clause 74, wherein the client identifier is designated for one-time use.

Clause 76: The computer-implemented method of Clause 74, wherein the one or more second parameters comprise at least one of (i) a nonce generated by the second AP MLD, (ii) an ephemeral public key generated by the second AP MLD, (iii) one or more key derivation parameters, (iv) a message integrity check (MIC) generated based on the PTK associated with the second AP MLD, (v) a status of at least one of the link setup or the transfer of the security context.

Clause 77: The computer-implemented method of Clause 76, further comprising verifying the MIC in the roaming preparation response frame.

Clause 78: The computer-implemented method of Clause 70, further comprising generating the PTK for the second AP MLD, based at least in part on the one or more second parameters.

Clause 79: The computer-implemented method of Clause 70, further comprising transmitting a roaming confirmation frame to the second AP MLD.

Clause 80: The computer-implemented method of Clause 79, wherein the roaming confirmation frame is a protected management frame (PMF) protected using the PTK established for the second AP MLD.

Clause 81: The computer-implemented method of Clause 80, wherein the roaming confirmation frame comprises a message integrity check (MIC) generated based in part on the PTK established for the second AP MLD.

Clause 82: A computer-implemented method for wireless communication performed by a first access point (AP) multi-link device (MLD) of a seamless mobility domain (SMD), comprising: receiving a roaming request frame from a client device associated with the SMD comprising a plurality of AP MLDs including the first AP MLD, wherein the SMD supports seamless roaming using a single pairwise transient key (PTK) mode where a single PTK is shared across the plurality of AP MLDs; determining, based on one or more parameters in the roaming request frame, a pairwise transient key security association (PTKSA) corresponding to the single PTK; generating, based on processing the roaming request frame using the single PTK, a roaming response frame indicating whether roaming of the client device to the first AP MLD is successful; transmitting the roaming response frame to the client device; and responsive to indicating that roaming is successful, communicating with the client device to exchange one or more data frames, wherein the communication is secured using the single PTK.

Clause 83: The computer-implemented method of Clause 82, wherein the roaming request frame is a protected management frame (PMF).

Clause 84: The computer-implemented method of Clause 83, wherein the one or more parameters comprise a transmitter address included in a header of the roaming request frame.

Clause 85: The computer-implemented method of Clause 84, wherein determining the PTKSA corresponding to the single PTK comprises mapping the transmitter address to the PTKSA for the client device within the SMD.

Clause 86: The computer-implemented method of Clause 83, wherein processing the roaming request frame comprises decrypting at least a portion of the roaming request frame using the single PTK.

Clause 87: The computer-implemented method of Clause 83, wherein the roaming request frame is received without receiving roaming preparation signaling from the client device via a second AP MLD of the plurality of AP MLDs via which the client device is communicating.

Clause 88: The computer-implemented method of Clause 87, further comprising, prior to receiving the roaming request frame, receiving a roaming preparation request frame from the client device.

Clause 89: The computer-implemented method of Clause 88, wherein the roaming preparation request frame is unencrypted.

Clause 90: The computer-implemented method of Clause 88, wherein the roaming preparation request frame comprises a client identifier and an identifier of the second AP MLD.

Clause 91: The computer-implemented method of Clause 88, wherein the roaming preparation request frame comprises a message integrity check (MIC) generated using the single PTK.

Clause 92: The computer-implemented method of Clause 91, further comprising verifying the MIC in the roaming preparation request frame using the PTKSA corresponding to the single PTK.

Clause 93: The computer-implemented method of Clause 88, further comprising transmitting, to the client device, a roaming preparation response frame in response to the roaming preparation request frame.

Clause 94: The computer-implemented method of Clause 93, wherein the roaming preparation response frame comprises a message integrity check (MIC) generated using the single PTK.

Clause 95: The computer-implemented method of Clause 94, wherein the roaming preparation response frame is transmitted based on successful verification of the MIC in the roaming preparation request frame.

Clause 96: The computer-implemented method of Clause 82, further comprising, prior to processing the roaming request frame, obtaining the single PTK from a controller, a key store, or a second AP MLD of the plurality of AP MLDs.

Clause 97: The computer-implemented method of Clause 96, wherein the single PTK is obtained on demand in response to receiving the roaming request frame.

Clause 98: The computer-implemented method of Clause 82, wherein processing the roaming request frame using the single PTK is performed prior to installing the single PTK in hardware of the first AP MLD.

Clause 99: The computer-implemented method of Clause 98, further comprising installing the single PTK in hardware of the first AP MLD after determining that roaming is successful.

Clause 100: The computer-implemented method of Clause 82, wherein the roaming request frame comprises at least one of an unencrypted portion or an encrypted portion.

Clause 101: The computer-implemented method of Clause 100, wherein the unencrypted portion comprises a robust security network element (RSNE) or a multi-link (ML) element.

Clause 102: The computer-implemented method of Clause 100, wherein the unencrypted portion comprises a client identifier associated with the client device.

Clause 103: The computer-implemented method of Clause 102, wherein the client identifier comprises (i) a pairwise master key identifier (PMKID), (ii) a non-AP MLD identifiable random medium access control (MAC) address (IRM), (iii) a roaming non-AP MLD MAC address, or (iv) a combination thereof.

Clause 104: The computer-implemented method of Clause 102, wherein determining the PTKSA corresponding to the single PTK comprises mapping the client identifier to the PTKSA for the client device within the SMD.

Clause 105: The computer-implemented method of Clause 100, wherein the encrypted portion of the roaming request frame is encrypted using the single PTK.

Clause 106: The computer-implemented method of Clause 105, wherein processing the roaming request frame comprises decrypting the encrypted portion using the single PTK in software.

Clause 107: The computer-implemented method of Clause 100, wherein the encrypted portion of the roaming request frame is encrypted using a signaling key established during an initial association with the SMD.

Clause 108: The computer-implemented method of Clause 107, wherein processing the roaming request frame comprises decrypting the encrypted portion using the signaling key.

Clause 109: The computer-implemented method of Clause 82, wherein the roaming request frame comprises a message integrity check (MIC).

Clause 110: The computer-implemented method of Clause 109, further comprising verifying the MIC using the single PTK or a signaling key established during an initial association with the SMD.

Clause 111: The computer-implemented method of Clause 110, wherein the MIC is generated over at least one of: (i) at least a portion of an encrypted portion of the roaming request frame or (ii) at least a portion of an unencrypted portion of the roaming request frame.

Clause 112: The computer-implemented method of Clause 82, wherein the roaming response frame is a protected management frame (PMF).

Clause 113: The computer-implemented method of Clause 82, wherein the roaming response frame comprises at least one of an encrypted portion or an unencrypted portion.

Clause 114: The computer-implemented method of Clause 113, wherein the unencrypted portion of the roaming response frame comprises additional authentication data (AAD).

Clause 115: The computer-implemented method of Clause 82, wherein the roaming response frame comprises a message integrity check (MIC) generated using the single PTK or a signaling key established during an initial association with the SMD.

Clause 116: The computer-implemented method of Clause 82, wherein the roaming response frame comprises one or more updated client identifiers for use in a subsequent roaming operation.

Clause 117: The computer-implemented method of Clause 82, further comprising receiving a roaming confirmation frame from the client device.

Clause 118: The computer-implemented method of Clause 117, wherein the roaming confirmation frame is a protected management frame (PMF).

Clause 119: A computer-implemented method for wireless communication performed by a first access point (AP) multi-link device (MLD) of a seamless mobility domain (SMD), comprising: receiving a roaming request frame from a client device associated with the SMD comprising a plurality of AP MLDs including the first AP MLD, wherein the SMD supports seamless roaming using a different pairwise transient key (PTK) mode where a separate PTK is generated for each AP MLD of the plurality of AP MLDs; determining, based on one or more parameters in the roaming request frame, a pairwise transient key security association (PTKSA) corresponding to the PTK associated with the first AP MLD; generating, based on processing the roaming request frame using the PTK associated with the first AP MLD, a roaming response frame indicating whether roaming of the client device to the first AP MLD is successful; transmitting the roaming response frame to the client device; and responsive to indicating that roaming is successful, communicating with the client device to exchange one or more data frames, wherein the communication is secured using the PTK associated with the first AP MLD.

Clause 120: The computer-implemented method of Clause 119, further comprising, prior to receiving the roaming request frame, establishing the PTK associated with the first AP MLD.

Clause 121: The computer-implemented method of Clause 120, wherein establishing the PTK associated with the first AP MLD comprises performing a roaming preparation procedure with the client device via a second AP MLD of the plurality of AP MLD via which the client device is communicating.

Clause 122: The computer-implemented method of Clause 120, wherein the roaming request frame is a protected management frame (PMF) protected using the PTK associated with the first AP MLD.

Clause 123: The computer-implemented method of Clause 122, wherein: the one or more parameters comprise a transmitter address that identifies the client device; and the transmitter address is included in a header of the roaming request frame.

Clause 124: The computer-implemented method of Clause 123, wherein determining the PTKSA comprises mapping the transmitter address to the PTKSA corresponding to the PTK associated with the first AP MLD.

Clause 125: The computer-implemented method of Clause 122, wherein processing the roaming request frame comprises decrypting at least a portion of the roaming request frame using the PTK associated with the first AP MLD.

Clause 126: The computer-implemented method of Clause 122, wherein the roaming response frame is a PMF protected using the PTK associated with the first AP MLD.

Clause 127: The computer-implemented method of Clause 120, wherein: the roaming request frame comprises at least one of an unencrypted portion or an encrypted portion; and the one or more parameters are included in the unencrypted portion.

Clause 128: The computer-implemented method of Clause 127, wherein the unencrypted portion comprises a robust security network element (RSNE) or a multi-link (ML) element.

Clause 129: The computer-implemented method of Clause 127, wherein the one or more parameters comprise a client identifier.

Clause 130: The computer-implemented method of Clause 129, wherein the client identifier comprises (i) a pairwise master key identifier (PMKID), (ii) a non-AP MLD identifiable random medium access control (MAC) address (IRM), (iii) a roaming non-AP MLD MAC address, or (iv) a combination thereof.

Clause 131: The computer-implemented method of Clause 129, wherein the client identifier is designated for one-time use.

Clause 132: The computer-implemented method of Clause 129, wherein determining the PTKSA comprises mapping the client identifier to the PTKSA corresponding to the PTK associated with the first AP MLD.

Clause 133: The computer-implemented method of Clause 129, wherein processing the roaming request frame comprises decrypting at least a portion of the encrypted portion of the roaming request frame using a signaling key established prior to roaming or the PTK associated with the first AP MLD.

Clause 134: The computer-implemented method of Clause 129, wherein the roaming response frame comprises at least one of an encrypted portion or an unencrypted portion.

Clause 135: The computer-implemented method of Clause 134, wherein the encrypted portion of the roaming response frame is encrypted using the PTK associated with the first AP MLD or a signaling key established prior to roaming.

Clause 136: The computer-implemented method of Clause 134, wherein the encrypted portion of the roaming response frame comprises one or more updated client identifiers available for use in a subsequent roaming operation.

Clause 137: The computer-implemented method of Clause 119, wherein the roaming request frame is received without the PTK associated with the first AP MLD having been previously established for the client device.

Clause 138: The computer-implemented method of Clause 137, further comprising generating the PTK associated with the first AP MLD based on the one or more parameters in the roaming request frame.

Clause 139: The computer-implemented method of Clause 138, wherein the one or more parameters comprise at least one of a nonce, an ephemeral public key, or one or more key derivation parameters.

Clause 140: The computer-implemented method of Clause 138, wherein the roaming response frame comprises one or more parameters usable by the client device to generate the PTK associated with the first AP MLD.

Clause 141: The computer-implemented method of Clause 138, wherein communicating with the client device using the PTK associated with the first AP MLD occurs after the PTK is generated.

Clause 142: The computer-implemented method of Clause 119, further comprising, prior to receiving the roaming request frame, receiving a roaming preparation request frame from the client device.

Clause 143: The computer-implemented method of Clause 142, wherein the roaming preparation request frame is unencrypted.

Clause 144: The computer-implemented method of Clause 142, wherein the roaming preparation request frame comprises at least one of a client identifier or an identifier of a second AP MLD of the plurality of AP MLDs via which the client device is communicating.

Clause 145: The computer-implemented method of Clause 142, further comprising transmitting a roaming preparation response frame in response to the roaming preparation request frame.

Clause 146: The computer-implemented method of Clause 145, wherein the roaming preparation response frame further comprises information usable to generate the PTK associated with the first AP MLD.

Clause 147: The computer-implemented method of Clause 145, wherein the roaming request frame is processed after transmitting the roaming preparation response frame.

Clause 148: The computer-implemented method of Clause 119, wherein the roaming request frame comprises a first message integrity check (MIC).

Clause 149: The computer-implemented method of Clause 148, further comprising verifying the first MIC using the PTK associated with the first AP MLD or a signaling key.

Clause 150: The computer-implemented method of Clause 148, wherein the roaming response frame comprises a second MIC.

Clause 151: The computer-implemented method of Clause 119, wherein the roaming request frame is processed in software prior to installing the PTK associated with the first AP MLD in hardware.

Clause 152: The computer-implemented method of Clause 151, further comprising installing the PTK associated with the first AP MLD in hardware after indicating that roaming is successful.

Clause 153: A computer-implemented method for wireless communications performed by a first access point (AP) multi-link device (MLD) of a seamless mobility domain (SMD), comprising: receiving a roaming preparation request frame from a client device associated with the SMD comprising a plurality of AP MLDs including the first AP MLD, wherein the SMD supports seamless roaming using a different pairwise transient key (PTK) mode where a separate PTK is generated for each AP MLD of the plurality of AP MLDs; generating a PTK corresponding to the first AP MLD for the client device, based on one or more first parameters in the roaming preparation request frame; transmitting, to the client device, a roaming preparation response frame comprising one or more second parameters associated with establishing the PTK for the first AP MLD; and communicating with the client device to exchange one or more data frames using the PTK established for the first AP MLD.

Clause 154: The computer-implemented method of Clause 153, wherein the roaming preparation request frame is received without receiving a roaming request frame from the client device.

Clause 155: The computer-implemented method of Clause 153, wherein roaming of the client device to the first AP MLD is completed without generating a roaming response frame.

Clause 156: The computer-implemented method of Clause 153, wherein the roaming preparation request frame is unencrypted.

Clause 157: The computer-implemented method of Clause 153, wherein the roaming preparation request frame comprises at least one of a client identifier or an identifier of a second AP MLD of the plurality of AP MLDs via which the client device is communicating.

Clause 158: The computer-implemented method of Clause 157, wherein the client identifier is designated for one-time use.

Clause 159: The computer-implemented method of Clause 153, wherein the one or more first parameters comprise at least one of (i) a client identifier, (ii) an identifier of the first AP MLD, (iii) a client nonce, (iv) ephemeral public key, (v) first information associated with link setup between the client device and the first AP MLD, or (vi) second information associated with transfer of a security context for the client device.

Clause 160: The computer-implemented method of Clause 159, wherein the one or more second parameters comprise at least one of (i) a nonce generated by the first AP MLD, (ii) an ephemeral public key generated by the first AP MLD, (iii) one or more key derivation parameters, (iv) a message integrity check (MIC) generated based on the PTK associated with the first AP MLD, (v) a status of at least one of the link setup or the transfer of the security context.

Clause 161: The computer-implemented method of Clause 153, wherein the roaming preparation request frame comprises a message integrity check (MIC).

Clause 162: The computer-implemented method of Clause 161, further comprising verifying the MIC using a key derived from a pairwise master key (PMK) associated with the SMD.

Clause 163: The computer-implemented method of Clause 161, wherein the MIC is generated over at least a portion of the roaming preparation request frame and additional authentication data.

Clause 164: The computer-implemented method of Clause 161, wherein the roaming preparation response frame is generated upon successful verification of the MIC in the roaming preparation request frame.

Clause 165: The computer-implemented method of Clause 153, wherein the PTK corresponding to the first AP MLD is established prior to any exchange of data frames with the client device.

Clause 166: The computer-implemented method of Clause 153, wherein the roaming preparation response frame comprises one or more updated client identifiers for use in a subsequent roaming operation.

Clause 167: The computer-implemented method of Clause 153, wherein the PTK corresponding to the first AP MLD is generated in software prior to installing the PTK in hardware of the first AP MLD.

Clause 168: The computer-implemented method of Clause 167, further comprising installing the PTK in hardware of the first AP MLD after transmitting the roaming preparation response frame.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A computer-implemented method for wireless communications performed by a client device, comprising:
determining that a wireless network supports seamless roaming within a seamless mobility domain (SMD) using a single pairwise transient key (PTK) mode where a single PTK is shared across a plurality of access point (AP) multi-link devices (MLDs) of the SMD;
associating with the SMD using the single PTK mode;
selecting, while associated with the SMD and communicating via a first AP MLD of the plurality of AP MLDs, a second AP MLD of the plurality of AP MLDs for roaming without performing a roaming preparation procedure via the first AP MLD;
transmitting a roaming request frame to the second AP MLD, the roaming request frame comprising one or more parameters associated with seamless roaming within the SMD;
receiving, from the second AP MLD in response to the roaming request frame, a roaming response frame indicating whether the roaming is successful; and
responsive to determining the roaming is successful, communicating with the second AP MLD to exchange one or more data frames, wherein the communication is secured using the single PTK.

2. The computer-implemented method of claim 1, wherein:
the roaming request frame is a protected management frame (PMF) protected using the single PTK;
the one or more parameters comprise a transmitter address that identifies the client device;
the transmitter address is included in a header of the roaming request frame; and
the roaming response frame is a PMF.

3. The computer-implemented method of claim 2, wherein the roaming response frame is a PMF.

4. The computer-implemented method of claim 2, wherein:
the roaming request frame is transmitted without having exchanged roaming preparation signaling with the second AP MLD via the first AP MLD;
the computer-implemented method further comprises prior to transmitting the roaming request frame, transmitting a roaming preparation request frame to the second AP MLD;
the roaming preparation request frame is unencrypted and comprises a client identifier and an identifier of the first AP MLD; and
the computer-implemented method further comprises receiving, from the second AP MLD, a roaming preparation response frame in response to the roaming preparation request frame.

5. The computer-implemented method of claim 1, wherein:
the roaming request frame comprises at least one of an unencrypted portion or an encrypted portion;
the one or more parameters are included in the unencrypted portion; and
the one or more parameters comprise a client identifier designated for one-time use.

6. The computer-implemented method of claim 5, wherein the roaming response frame comprises one or more updated client identifiers available for use in a subsequent roaming operation.

7. The computer-implemented method of claim 1, wherein:
the roaming request frame is unencrypted;
the roaming request frame comprises a message integrity check (MIC) parameter generated based on the single PTK;
the roaming response frame is unencrypted; and
the roaming response frame comprises a MIC parameter generated based on the single PTK.

8. A computer-implemented method for wireless communications performed by a client device, comprising:
determining that a wireless network supports seamless roaming within a seamless mobility domain (SMD) using a different pairwise transient key (PTK) mode where a separate PTK is generated for each access point (AP) multi-link device (MLD) of a plurality of AP MLDs of the SMD;
associating with the SMD using the different PTK mode;
selecting, while associated with the SMD and communicating via a first AP MLD of the plurality of AP MLDs, a second AP MLD of the plurality of AP MLDs for roaming;
transmitting a roaming request frame to the second AP MLD, the roaming request frame comprising one or more parameters associated with seamless roaming within the SMD;
receiving, from the second AP MLD in response to the roaming request frame, a roaming response frame indicating whether the roaming is successful; and
responsive to determining the roaming is successful, communicating with the second AP MLD to exchange one or more data frames, wherein the communication is secured using a PTK associated with the second AP MLD.

9. The computer-implemented method of claim 8, further comprising, transmitting a roaming confirmation frame to the second AP MLD, responsive to the roaming response frame.

10. The computer-implemented method of claim 8, further comprising, prior to transmitting the roaming request frame, establishing the PTK associated with the second AP MLD, wherein establishing the PTK associated with the second AP MLD comprises performing a roaming preparation procedure with the second AP MLD via the first AP MLD.

11. The computer-implemented method of claim 10, wherein the roaming request frame is a protected management frame (PMF) protected using the PTK associated with the second AP MLD.

12. The computer-implemented method of claim 11, wherein the roaming response frame is a PMF protected using the PTK associated with the second AP MLD.

13. The computer-implemented method of claim 10, wherein:
the roaming request frame comprises at least one of an unencrypted portion or an encrypted portion;
the one or more parameters are included in the unencrypted portion; and
the one or more parameters comprise a client identifier designated for one-time use.

14. The computer-implemented method of claim 13, wherein:
the encrypted portion of the roaming request frame is protected using a signaling key established prior to roaming or the PTK associated with the second AP MLD;
the roaming response frame comprises at least one of an encrypted portion or an unencrypted portion;
the encrypted portion of the roaming response frame is encrypted using the PTK associated with the second AP MLD or the signaling key established prior to roaming; and
the encrypted portion of the roaming response frame comprises one or more updated client identifiers available for use in a subsequent roaming operation.

15. The computer-implemented method of claim 8, wherein:
the roaming request frame is transmitted without previously establishing the PTK associated with the second AP MLD;
the computer-implemented method further comprises generating the PTK associated with the second AP MLD based on one or more parameters included in the roaming response frame; and
the communicating with the second AP MLD to exchange the one or more data frames is after the generating of the PTK associated with the second AP MLD.

16. The computer-implemented method of claim 15, wherein:
the one or more parameters in the roaming request frame comprise at least one of (i) a client identifier, (ii) an identifier of the first AP MLD, (iii) a client nonce, (iv) a Diffie-Hellman (DH) public key, (v) first information associated with link setup between the client device and the second AP MLD, or (vi) second information associated with transfer of a security context for the client device; and
the one or more parameters in the roaming response frame comprise at least one of (i) a nonce generated by the second AP MLD, (ii) a DH public key generated by the second AP MLD, (iii) one or more key derivation parameters, (iv) a message integrity check (MIC) generated based on the PTK associated with the second AP MLD, or (v) a status of at least one of the link setup or the transfer of the security context.

17. The computer-implemented method of claim 16, further comprising, transmitting a roaming confirmation frame to the second AP MLD, responsive to the roaming response frame.

18. The computer-implemented method of claim 17, wherein the roaming confirmation frame is encrypted with the PTK associated with the second AP MLD and comprises a message integrity check (MIC) generated based on the PTK associated with the second AP MLD.

19. The computer-implemented method of claim 15, further comprising, prior to transmitting the roaming request frame, transmitting a roaming preparation request frame to the second AP MLD, wherein:
the roaming preparation request frame is unencrypted; and
the roaming preparation request frame comprises at least one of a client identifier, an identifier of the first AP MLD, a client nonce, or a Diffie-Hellman (DH) public key of the client device.

20. The computer-implemented method of claim 19, further comprising receiving, from the second AP MLD in response to the roaming preparation request frame, a roaming preparation response frame, wherein the roaming preparation response frame is unencrypted and comprises at least one of a client identifier, a nonce, a DH public key or a message integrity check (MIC).
